(19) United States
(12) Patent Application Publication
(10) Pub. No.: US 2024/0114346 A1
(43) Pub. Date: Apr. 4, 2024

(54) CITIZEN BROADCAST RADIO SPECTRUM (CBRS) OPERATIONS

(71) Applicant: QUALCOMM Incorporated, San Diego, CA (US)

(72) Inventors: Abhishek Pramod PATIL, San Diego, CA (US); Gaurang NAIK, San Diego, CA (US); Abdel Karim AJAMI, Lakeside, CA (US); George CHERIAN, San Diego, CA (US); Alfred ASTERJADHI, San Diego, CA (US); Yanjun SUN, San Diego, CA (US); Sai Yiu Duncan HO, San Diego, CA (US)

(21) Appl. No.: 17/938,039

(22) Filed: Oct. 4, 2022

(51) Int. Cl. H04W 16/02; H04W 72/04

(52) U.S. Cl. CPC H04W 16/02; H04W 72/0453; H04W 84/042

(57) ABSTRACT

This disclosure provides methods, devices and systems for transmitting and receiving, between an access point (AP) and one or more stations (STAs) in a basic service set (BSS), within a 3.5 GHz bandwidth. In some examples, the AP may output, for transmission to a network node, a request for channel resources comprising an indication of one or more channel resources within a spectrum. In another example, the AP may obtain, from the network node, a response to the request, the response providing the apparatus with access to the indicated one or more channel resources within the spectrum.

### TECHNICAL FIELD

This disclosure relates generally to wireless communication, and more specifically, to methods and devices for wireless communication over semi-licensed and/or priority spectrums.

### DESCRIPTION OF THE RELATED TECHNOLOGY

Radio frequency (RF) spectrum is the foundation for many wireless communications systems in use today, including wireless local area network (WLAN), radar, and cellular communications systems. Specified frequency ranges, sometimes identified as bands or channels, in the RF spectrum may be allocated for use by different entities, for different purposes, or in different geographic locations. As used in this disclosure, “spectrum” refers to any frequencies, frequency bands, and frequency channels in the RF spectrum that may be used or allocated for wireless communications.

Because the available RF spectrum is finite, frequency allocations in the spectrum are highly valued and often highly regulated. In the United States, for example, the Federal Communications Commission (FCC) and the National Telecommunication and Information Administration (NTIA) regulate and manage spectrum allocations, allotments, and assignments. Frequency allocation is the process by which the entire RF spectrum is divided into frequency bands established for particular types of service. These frequency allocations are then further subdivided into channels designated for a particular service or “allotment.” Assignment refers to the final subdivision of the spectrum in which a party gets one or more frequency assignments, in the form of a license, to operate a radio transmitter on specific frequencies within a particular geographic location.

The system of spectrum allocation, allotment, and assignment is failing to keep pace with the increasing demand for spectrum. There is therefore a need to improve how the available spectrum and future spectrum can be efficiently allocated and used in the face of growing demand. Unless otherwise noted, “allocation” is used in the present disclosure to generally refer to the process by which spectrum is allocated, allotted, and assigned to licensed users.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects are directed to an apparatus configured for wireless communication. In some examples, the apparatus includes a memory comprising instructions and one or more processors. In some examples, the one or more processors are configured to execute the instructions and cause the apparatus to output, for transmission to a network node, a request for channel resources comprising an indication of one or more channel resources within a spectrum. In some examples, the one or more processors are configured to execute the instructions and cause the apparatus to obtain, from the network node, a response to the request, the response providing the apparatus with access to the indicated one or more channel resources within the spectrum.

Aspects are directed to a method for wireless communication by an apparatus. In some examples, the method includes outputting, for transmission to a network node, a request for channel resources comprising an indication of one or more channel resources within a spectrum. In some examples, the method includes obtaining, from the network node, a response to the request, the response providing the apparatus with access to the indicated one or more channel resources within the spectrum.

Aspects are directed to an apparatus for wireless communication. In some examples, the apparatus includes means for outputting, for transmission to a network node, a request for channel resources comprising an indication of one or more channel resources within a spectrum. In some examples, the apparatus includes means for obtaining, from the network node, a response to the request, the response providing the apparatus with access to the indicated one or more channel resources within the spectrum.

Aspects are directed to a non-transitory computer-readable medium comprising instructions that, when executed by an apparatus, cause the apparatus to perform a method. In some examples, the method includes outputting, for transmission to a network node, a request for channel resources comprising an indication of one or more channel resources within a spectrum. In some examples, the method includes obtaining, from the network node, a response to the request, the response providing the apparatus with access to the indicated one or more channel resources within the spectrum.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a pictorial diagram illustrating an example wireless communication network.

FIG. 2 is a diagram illustrating hardware aspects of an access point (AP) and two stations (STAs).

FIG. 3 is a schematic diagram of a three-tiered organization for a new operational band and an example basic service set (BSS).

FIG. 4 is a diagram illustrating an example citizen band radio spectrum CBRS frequency spectrum.

FIG. 5 is a diagram illustrating an example frequency spectrum.

FIG. 6 is a diagram illustrating another example frequency spectrum.

FIG. 7 is a block diagram illustrating an example structure of a dedicated service period (D-SP) and opportunistic service period (O-SP).

FIG. 8 is another block diagram illustrating an example structure of a dedicated service period (D-SP) and opportunistic service period (O-SP).

FIG. 9 is a flow diagram illustrating an example method of wireless communication.

FIG. 10 is a flow diagram illustrating a method of wireless communication as an alternative to in addition to the method of FIG. 9.

FIG. 11 is a flow diagram illustrating a method of wireless communication as an alternative to in addition to the method of FIG. 9.

FIG. 12 is a flow diagram illustrating a method of wireless communication as an alternative to in addition to the method of FIG. 9.

FIG. 13 is a flow diagram illustrating a method of wireless communication as an alternative to in addition to the method of FIG. 9.

FIG. 14 is a flow diagram illustrating a method of wireless communication as an alternative to in addition to the method of FIG. 9.

FIG. 15 is a flow diagram illustrating a method of wireless communication as an alternative to in addition to the method of FIG. 9.

FIG. 16 is a flow diagram illustrating a method of wireless communication as an alternative to in addition to the method of FIG. 9.

FIG. 17 is a flow diagram illustrating a method of wireless communication as an alternative to in addition to the method of FIG. 9.

FIG. 18 is a flow diagram illustrating a method of wireless communication as an alternative to in addition to the method of FIG. 9.

FIG. 19 is a flow diagram illustrating a method of wireless communication as an alternative to in addition to the method of FIG. 9.

FIG. 20 is a flow diagram illustrating a method of wireless communication as an alternative to in addition to the method of FIG. 9.

FIG. 21 is a flow diagram illustrating a method of wireless communication as an alternative to in addition to the method of FIG. 9.

FIG. 22 is a flow diagram illustrating a method of wireless communication as an alternative to in addition to the method of FIG. 9.

FIG. 23 is a flow diagram illustrating a method of wireless communication as an alternative to in addition to the method of FIG. 9.

FIG. 24 is a flow diagram illustrating a method of wireless communication as an alternative to in addition to the method of FIG. 9.

FIG. 25 is a flow diagram illustrating a method of wireless communication as an alternative to in addition to the method of FIG. 9.

FIG. 26 is a flow diagram illustrating a method of wireless communication as an alternative to in addition to the method of FIG. 9.

FIG. 27 depicts an example communications device that includes various components operable, configured, or adapted to perform operations for the techniques disclosed herein, such as the operations depicted and described with respect to FIGS. 9-26.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU)-MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network. As used herein, the term “communicating” or “communication” may relate to wireless communication (e.g., transmission and/or reception of data and/or control channels) on one or more operational bands.

In certain aspects, the disclosure is directed to rules for enabling Wi-Fi operations on new spectrum available in different regions of the world. In some examples, the portion of the new spectrum can be leased for a certain amount of time (also termed as priority spectrum). Leasing a portion of the spectrum provides a limited ownership of the spectrum under certain conditions. In some examples, a non-priority portion of the new spectrum is available for anyone to use. Both the non-priority and priority portions of the new spectrum may be shared with non-Wi-Fi users. In some other cases, a Wi-Fi device needs to vacate the spectrum if an incumbent arrives.

As discussed herein, as an example is the citizen broadband radio spectrum (CBRS) is a 150 MHz band in a 3.55-3.7 GHz range. The CBRS is specific to the United States, and other regions may have different size and location of the new spectrum and may refer to it with a different name. The CBRS operates using a three-tiered user model with priority given a first tier of users called “incumbents,” a second tier of users using a priority access license (PAL), and a third tier with the least priority called general authorized access (GAA). Incumbent users are typically users that belong to a government or military establishment and are given the highest priority for use of the CBRS. Users of the PAL tier are typically users who have paid to lease portion of the CBRS for a duration of time. A PAL user has pseudo-ownership of the portion of the spectrum it has paid for but will have to vacate the spectrum if an incumbent arrives. The GAA users typically have the least priority and will need to vacate the spectrum/channel if an incumbent or a PAL user occupies the spectrum/channel. Accordingly, the total available spectrum of CBRS is 150 MHz, of which all 150 MHz is available for incumbents, a 70 MHz portion is available for PALs, and a remaining 80 MHz portion is available for GAAs.

Presently, there is consideration of whether the CBRS spectrum may be used for Wi-Fi operations. That is, Wi-Fi devices, such as access points (APs) and stations (STAs) may use the CBRS spectrum for 802.11 communications. However, without any guidance, such devices may crowd the 3.5 GHz band causing interference to each other. Accordingly, aspects of the disclosure are directed to methods of communication with an objective for reducing or eliminating potential interference between Wi-Fi devices.

In a first example, a first AP may be configured to setup its primary 20 MHz band within the PAL spectrum for Wi-Fi communications. Because a PAL user has protection against GAA users, the primary band may be subject to reduced interference relative to an example where the primary band is in the GAA.

In some examples, the first AP may be configured to request a minimum 40 MHz spectrum in PAL for setting up its BSS. Here, because the remaining PAL spectrum would be 30 MHz, a similarly configured second AP would be prevented from requesting any PAL spectrum. Such a configuration may provide a single AP or multiple APs of a multi-link entity with a virtual monopoly over the PAL spectrum. Without any other devices communicating over the PAL spectrum, there may be reduced interference.

In some examples, the second AP may set up a BSS using a punctured CBRS spectrum (e.g., multiple channels that may or may not be contiguous in the frequency domain within the CBRS spectrum). Here, the second AP may request the remaining 30 MHz of the PAL spectrum, as well as one or more GAA channel(s), thus creating a puncturing pattern of the CBRS spectrum. Further, the second AP may update its puncturing pattern if there is any change (e.g., an incumbent begins using part of the remaining 30 MHz of the PAL spectrum or punctured part of the GAA). In this example, a spectrum access system (SAS) may inform the second AP that it can no longer use one or more portions of the CBRS spectrum, but may provide the second AP with information on other portions of the CBRS that are unoccupied.

In some examples, an STA or client device (such as a mobile phone) that is capable of communicating with the SAS can setup Wi-Fi operations on the CBRS band by operating as a mobile AP. In some examples, the device can communication with the SAS via cellular backhaul (such as LTE, 5G, 6G, etc.).

In some examples, multiple APs may setup a 160 MHz punctured BSS, with reuse of a primary channel. Here, an enterprise or organization (e.g., multiple APs working together) may take ownership of 40 MHz in PAL spectrum. In this example, multiple of the APs may use the same 20 MHz subchannel as a primary channel. Thus, multiple APs may communicate via the punctured CBRS spectrum. In some examples, the APs may perform coordinated AP (CAP) to coordinate and schedule their transmissions (e.g., C-TDMA, C-OFDMA, C-SR) and reduce or eliminate interference.

Typically, a Wi-Fi system operates on 20 MHz subchannels (i.e., the smallest size of a typical Wi-Fi channel is 20 MHz). In certain systems, a Wi-Fi device may be configured to operate on a 10 MHz channel. In such case, a Wi-Fi chip that typically works on 20 MHz channel will be down clocked to operate on 10 MHz channel.

In certain aspects, multiple APs may share the PAL spectrum if each of the multiple APs is configured to request only 10 or 20 MHz of bandwidth within the PAL. In this example, the PAL can allow up to six or three BSSs (e.g., six or three different APs). Each of the multiple APs may setup a punctured 160 MHz sharing the bandwidth amongst themselves. In some examples, the APs may perform coordinated AP (CAP) to coordinate and schedule their transmissions (e.g., C-TDMA, C-OFDMA, C-SR) and reduce or eliminate interference.

In some examples, an AP may setup its primary as a 10 MHz channel within the CBRS band. In some example, multiple APs may share the CBRS spectrum by setting up a shared primary channel on 10 MHz a channel. The primary channel can be located within the PAL spectrum or can be either in PAL or GAA.

In some examples, because the CBRS spectrum contains a 150 MHz spectrum, one or more APs communicating within the spectrum may treat a 10 MHz channel at the end of the CBRS spectrum and/or any other remaining channel(s) in the PAL spectrum as separate link(s). For example, the 10 MHz channel may be used as a control channel for feedback among APs (e.g., AP-to-AP coordination between APs communicating using CBRS resources) and/or AP-to-STA signaling/feedback. Because the channel is a 10 MHz channel, the traditional 20 MHz formatting (e.g., the 20 MHz preamble and physical layer protocol data unit (PPDU)) may not apply. Accordingly, the APs and STAs may use other formats that allow 10 MHz operation (e.g., 11a (non-HT) half rate PPDU or 11p PPDU).

In certain aspects, in order to meet regulatory requirements, an AP communicating within the CBRS spectrum may lower its transmit power and/or adjust other transmit parameters to reduce the potential for its signals to interference with communications of other devices nearby. An AP may also adjust its spectral mask to avoid causing interference into adjust channels within the PAL spectrum that it has not leased. In some examples, an AP may advertise its maximum transmit power in its beacon/probe response frames to control the transmission power of a client. Power control can also be used by an operator (e.g., an operator of multiple APs), who has leased resources of the PAL spectrum, to setup multiple non-overlapping BSSs in a given area. As noted, an operator may lower transmission power to keep BSS coverage small and to prevent overlapping of BSSs, thereby reducing/eliminating interference amongst friendly BSSs.

In certain aspects, an AP may operate using one of two modes of operation. In a first mode of operation, a first AP may be configured to communicate using a 3.5 GHz radio while a second AP is configured for non-3.5 GHz. The first AP and the second AP may be collocated with at least one other AP, and they may form part of a multi-link framework (e.g., affiliated with an AP MLD). A second mode of operation relates to an AP configured as a standalone 3.5 GHz radio. In some examples, when an incumbent occupies a 3.5 GHz channel, the 3.5 GHz channel becomes unavailable. In a scenario where an AP is removed or suspended from the 3.5 GHz channel to accommodate an incumbent, a lack of an AP's trigger frame (TF) and/or an indication in a beacon/probe on a non-3.5 GHz link may serves as an indication of unavailability of the 3.5 GHz channel or portions of the 3.5 GHz spectrum to one or more clients.

In certain aspects, an AP MLD may be configured to remove or disable an AP communicating over the 3.5 GHz band. For example, the AP MLD may use a TID-to-Link mapping procedure to disable the AP. Here, an AP configured for ML reconfiguration may initiate a removal procedure by transmitting a frame that includes a timer indicating when the AP should be removed from the 3.5 GHz band. In some examples, the AP MLD may provide the AP with a do-not-transmit (or link disabled) indication via a reduced neighbor report (RNR) element.

In some cases, the SAS may provide an AP with an alternative channel within the PAL and/or GAA to an AP that is removed or disabled from communicating over a particular channel of the 3.5 GHz band. In such a case, the AP may move its BSS to a different channel suggested by the SAS on the 3.5 GHz via the MLO framework using the Channel Switch Announcement (CSA) or Extended Channel Switch Announcement (ECSA) procedure. For example, the AP may advertise CSA or ECSA via the per-STA profile of 3.5 GHz advertised on a non-3.5 GHz link.

Certain aspects may relate to dedicated service periods (D-SPs). For example, an AP and an STA may negotiate and setup one or more service periods on the 3.5 GHz link for frame exchange, wherein at least one of the service periods is a D-SP. Scheduling of service periods on a 3.5 GHz link may be negotiated on a non-3.5 GHz link (e.g., in case the 3.5 GHz is part of an AP MLD w/multiple link). In some examples, a D-SP is a predetermined time reserved for serving a non-AP (e.g., STA), and the same D-SP may be shared with one or more STAs. In some examples, negotiations and updates for setting up D-SP are performed on the non-3.5 GHz band. Here, a target wake time (TWT) setup frame transmitted over the non-3.5 GHz band may carry a link ID for the 3.5 GHz.

In certain aspects, an AP that is communicating over one or more channels in the CBRS spectrum may be configured to check-in with the SAS frequently to confirm the availability of the one or more 3.5 GHz CBRS channels. If the SAS indicates that the AP can no longer communicate over the one or more CBRS channels, then the AP may be configured to inform its clients of the change. In one example, if the CBRS channels are still available for communication, the AP may transmit a trigger frame (TF) at the beginning of a service period. The TF can be buffer status report poll (BSRP) trigger frame, a multi-user request to send (MU-RTS) or clear-to-send (CTS) frame, or any suitable frame configured to poll one or more clients. Here, the TF is configured to indicate that the 3.5 GHz is still available for communication between the AP and the one or more clients.

A service period (e.g., D-SP, opportunistic service period (O-SP), and/or enhanced distributed channel access (EDCA)-based service period (E-SP)) can be shared by multiple clients, and the AP may indicate via a TF which client(s) it intends to serve during that SP.

In some examples, an AP MLD may setup O-SPs during ‘gaps’ between D-SPs. An O-SP may be advertised to clients via non-3.5 GHz links. An O-SP may be a supplementary service period to D-SP(s) and may provide additional time (e.g., opportunity) for the AP and one or more clients to complete communication of any pending frames which could not be serviced during a D-SP. For example, at the end of a D-SP, if the AP has remaining downlink buffer units (BUs) for an STA or has received an indicate of pending uplink BUs at the STA (e.g., via buffer status report (BSR) or any other suitable communication), then the AP may identify, in a transmission to the STA, an O-SP within the current beacon interval (BI) that the AP and STA can use to resume the communication.

In addition to the D-SP and O-SP described above, the AP may also setup one or more E-SPs for channel access. For example, during a D-SP or O-SP, the AP may transmit a TF to the one or more STAs, wherein the TF is configured to indicate if a 3.5 GHz channel is available or not. However, since any device can access the medium during an E-SP, the AP may also indicate whether the 3.5 GHz channel is available for communications during an E-SP. In one example, an AP MLD may transmit a beacon/probe response frame on a non-3.5 GHz channel that indicate whether the 3.5 GHz link is available for communication over any of a D-SP, an O-SP, and/or an E-SP. Here, the beacon/probe response frame may indicate whether channel access is granted and if so, for how long (e.g., channel available for another 15 BIs). Channel availability of the 3.5 GHz channel may be refreshed each time the AP pings the SAS and receives a response. Such signaling can be included even for a fully scheduled system so that client devices can power-save by not waking up on the 3.5 GHz link if channel is currently unavailable.

Certain aspects are directed to single-radio or stand-alone mode devices. For example internet-of-things (IoT) devices or always associated devices. In some examples, communication of management frames over a 3.5 GHz channel may reduced or eliminated by communicating such frames using out-of-band onboarding. For example, AP discovery, authentication, and association may take place during onboarding (one-time), while periodic keep-alive communications for extend the association may be communicated over the 3.5 GHz channel. In some examples, (re)discovery and (re)association communications, if needed, may be performed over the 3.5 GHz channel but such communications may be limited to certain service periods to avoid spurious access.

In some examples, communications between APs and clients over 3.5 GHz radio may be performed in a fully scheduled uplink transmission mode. For example, single user (SU) uplink access or EDCA uplink access may be limited to certain pre-announced durations/service periods for BSR and other signaling over the 3.5 GHz band, whereas only trigger-based access is allowed during the remaining time.

In some examples, communications over the 3.5 GHz band may be configured to reduce beacon transmissions. Beacon frames may be used for maintenance reasons, including timing synchronization function (TSF) updates. However, beacons may be transmitted less often since BU delivery is achieved using scheduled transmissions.

In some examples, clients may wake up for pre-assigned/dedicated (e.g., TWT) service periods. For example, APs and STAs may utilize a dynamic, on-demand (e.g., configured via TWT) service period (e.g., O-SP) to handle the traffic that spills over from the dedicated service period. In some examples, periodic service periods may be reserved for UL SU/EDCA access.

In some examples, stand-alone mode may be vulnerable to an incumbent arrival that disrupts BSS communications over a 3.5 GHz channel. Such a disruption may be minimized by switching from the 3.5 GHz band to a 2.4/5/6 GHz band.

Certain aspects are directed to a scheduling scheme for stand-alone mode that allows for minimal or controlled EDCA in addition to trigger-based scheduling. For example, in addition to the D-SP and O-SP, an AP may be configured to assign TWT service periods for clients to use EDCA for SU PPDU transmission and EDCA-SPs (E-SP). Clients may be configured to use E-SP to send unscheduled traffic, management frames etc.

Certain aspects are directed to a scenario where the 3.5 GHz AP is part of an AP MLD that has other APs operating on non-3.5 GHz bands. In such scenarios, certain criteria may first need to be satisfied before a 3.5 GHz link is part of a multi-link (ML) association with the AP MLD. For example, a reduced neighbor report (RNR) element may be configured to indicate such a restriction, and a multi-link probe response may be configured to provide the condition or criteria to be satisfied. When the indicated conditions are met, the 3.5 GHz link can be added to an existing ML association via (1:1) ML reconfiguration “add” operation. Likewise, a 3.5 GHz link may be removed from an existing ML setup via (1:1) ML reconfiguration “delete” operation when the conditions are no longer satisfied. For example, monetary payment may be a condition for access to the 3.5 GHz link for a specific amount of time.

As discussed above, TWT is given as example signaling for setting up service periods. However, other signaling for representing service periods for a 3.5 GHz channel may be used instead of TWT. For example, BSS transmissions may be fully scheduled so that the client is informed that the 3.5 GHz channel is available and that the AP intends to serve the client during scheduled SP. As such, a TWT may not apply or be needed for scheduled 3.5 GHz communications. By eliminating or reducing transmission of a TWT in the 3.5 GHz channel, overhead may be significantly reduced.

In some examples, a BI may be divided into X equal size time-blocks (TBs), each of size BI/X. For example, a 100 millisecond BI may be divided into 80 equal size TBs (e.g., the size of each TB being 1.25 milliseconds). Each TB can be identified by a corresponding single bit of an 80-bit bitmap (e.g., 80 bits=10 octets). Thus, an AP and client may negotiate and represent their schedules in terms of a 10 octet bitmap. Differently sized bitmaps may be used depending on the size of each TB and the size of the BI.

Scheduling within a BI may be represented in terms of TB. For example, 2 TBs for target beacon transmission time (TBTT) (e.g., beacon transmission). The rest of the time in a BI may be allocated to clients based on the client's traffic needs (e.g., D-SPs and O-SPs). In some examples, a beacon frame in non-3.5 GHz link may carry a bitmap indicating which TBs are available or in use (e.g., via a 0 or 1 value of a bit). The STA may negotiate (1:1) on the non-3.5 GHz band to add or remove TBs, and the STA may request that the AP add blocks if the bit position indicated is 0. The AP may accept or deny the request, or may propose an alternative. The AP may provide one or more clients with a schedule by transmitting over other links with each bit set to 1 for a slot that is allocated.

As used herein, a “legacy band” may refer to an operational band that is used by most modern electronics for wireless communication. Whereas “a new operational band” may refer to an operational band this is newly allowed for wireless communication. Thus, many wireless communication devices may not be configured to communicate over the new operational band.

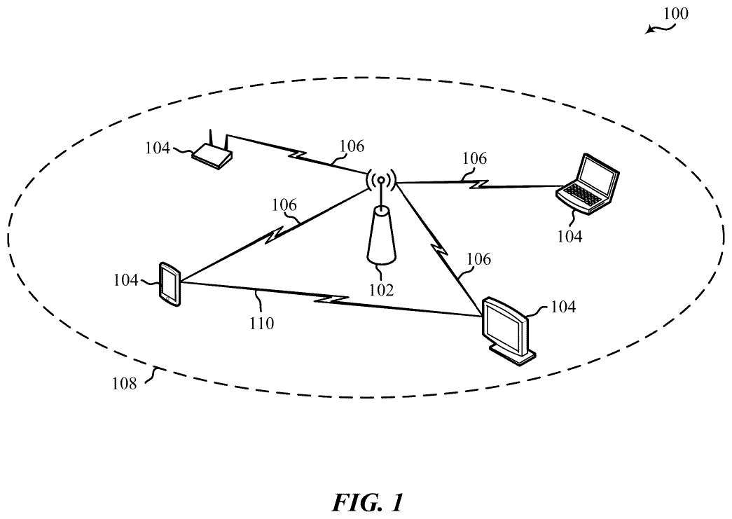

FIG. 1 is a network schematic illustrating an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). The WLAN 100 may include numerous wireless communication devices such as an access point (AP) 102 and multiple stations (STAs) 104. While only one AP 102 is shown, the WLAN network 100 also can include multiple APs 102 (e.g., MLD AP).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 periodically broadcasts beacon frames including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 108, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 108) according to the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple subchannels or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

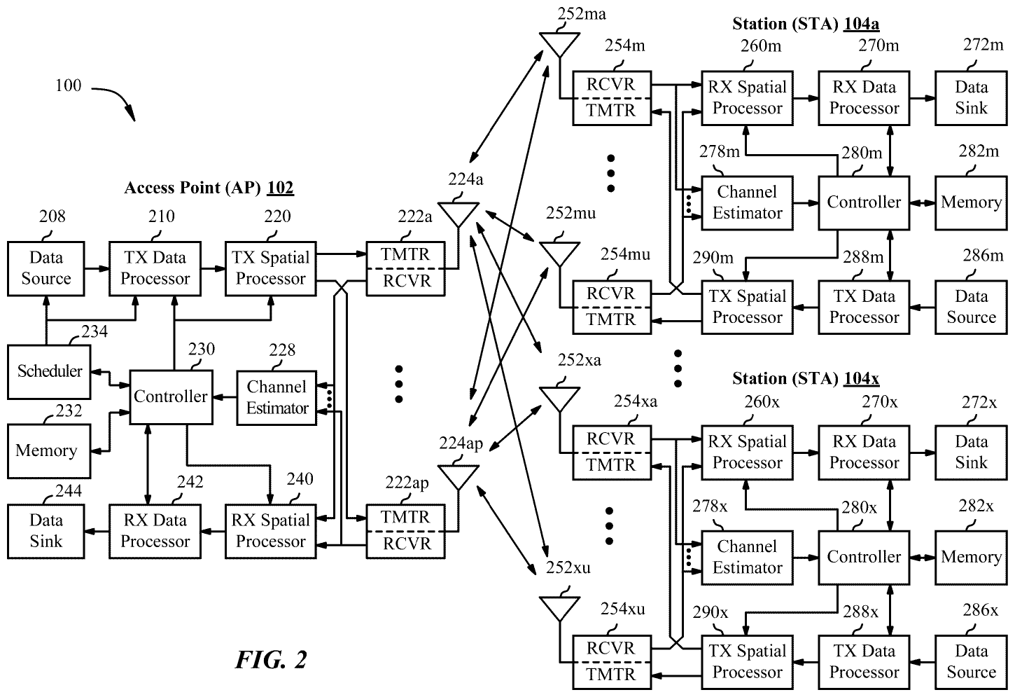

FIG. 2 illustrates a block diagram of an AP 102 and two STAs 104a and 104x in a BSS. The AP 102 is equipped with Nₜ antennas 224a through 224t. STA 120m is equipped with N_{ut,m} antennas 252ma through 252mu, and STA 120x is equipped with N_{ut,x} antennas 252xa through 252xu. The AP 102 is a transmitting entity for the downlink and a receiving entity for the uplink. Each STA 104 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each STA 104 selected for uplink transmission, a transmit (TX) data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the AP 102.

Nᵤₚ STAs may be scheduled for simultaneous transmission on the uplink. Each of these STAs performs spatial processing on its data symbol stream and transmits its set of transmit symbol streams on the uplink to the AP 102.

At the AP 102, Nₐₚ antennas 224a through 224ap receive the uplink signals from all Nᵤₚ STAs transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective STA. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at AP 102, a TX data processor 210 receives traffic data from a data source 208 for N_{dn} STA scheduled for downlink transmission, control data from a controller 230, and possibly other data from a scheduler 234. The various types of data may be sent on different transport channels. TX data processor 210 processes (e.g., encodes, interleaves, and modulates) the traffic data for each STA based on the rate selected for that STA. TX data processor 210 provides N_{dn} downlink data symbol streams for the N_{dn} STA. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the STA.

At each STA 120, N_{ut,m} antennas 252 receive the Nₐₚ downlink signals from AP 102. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the STA. The receiver spatial processing is performed in accordance with the CCMI, MMSE or some other technique. An RX data processor 270 processes (e.g., demodulates, deinterleaves and decodes) the recovered downlink data symbol stream to obtain decoded data for the STA.

At each STA 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each STA typically derives the spatial filter matrix for the user terminal based on the downlink channel response matrix H_{dn,m} for that user terminal. Controller 230 derives the spatial filter matrix for the access point based on the effective uplink channel response matrix H_{up,ef}f. Controller 280 for each STA may send feedback information (e.g., the downlink and/or uplink eigenvectors, eigenvalues, SNR estimates, and so on) to the access point. Controllers 230 and 280 also control the operation of various processing units at AP 102 and STA 104, respectively.

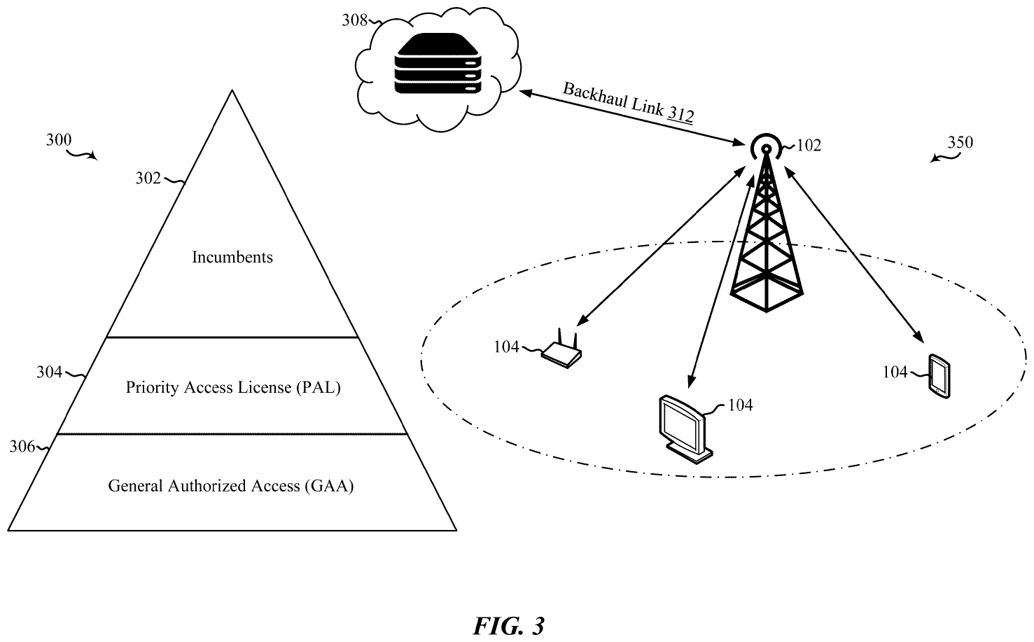

FIG. 3 is a schematic diagram of a three-tiered organization 300 for a new operational band (e.g., a 3.5 GHz operational band) including a spectrum access system (SAS) 308, an AP 102 operating as a citizens band service device (CBSD), incumbent systems 302, priority access license (PAL) systems 304, and general authorized access systems 306 that may be used in accordance with the disclosed embodiments. The CB SD and the PAL spectrums are examples of semi-licenses and priority spectrums. That is, portions of the spectrum can be leased while other portions are unlicensed an available for anyone to use. Wi-Fi devices may be required to vacate the spectrum if an incumbent arrives. In 2016, the FCC made available citizens broadband radio service (CBRS) spectrum in the 3550-3700 MHz (3.5 GHz) band, making 150 MHz of spectrum available for mobile broadband and other commercial users. The CBRS is unique, in that it makes available a comparatively large amount of spectrum (frequency bandwidth) without the need for expensive auctions, and without ties to a particular operator or service provider. It should be noted that while CBRS is specific to the United States, other regions may have different size and location of the new spectrum and may refer to it with a different name. The features of this disclosure apply with equal force to these spectrums.

Incumbent access (existing department of defense (DOD) and satellite) include authorized federal and grandfathered fixed satellite service (FSS) users currently operating in the 3.5 GHz band. These users may be protected from harmful interference from PAL systems 304 and GAA systems 306.

Typically, a Wi-Fi system operates on 20 MHz subchannels (i.e., the smallest size of a typical Wi-Fi channel is 20 MHz). In certain systems, a Wi-Fi device may be configured to operate on a 10 MHz channel. In such case, a Wi-Fi chip that typically works on 20 MHz channel will be down clocked to operate on 10 MHz channel. The PAL systems 304 may operate on priority access licenses that will be assigned using competitive bidding within the 3550-3650 MHz portion of the band. Each PAL is defined as a non-renewable authorization to use a 10 MHz channel in a single census tract for a number of years. Any suitable number of PALs may be assigned in any given census tract, with potentially multiple PALs going to any single applicant. In one example, up to 7 PALs may be allowed within a census tract, with no more than 4 PALs going to a single applicant. However, any suitable number of assignments and/or licenses may be used.

The GAA systems 306 (for any user with an authorized 3.5 GHz device) may be licensed-by-rule to permit open, flexible access to the band for the widest possible group of potential users. GAA systems 306 may be permitted to use any portion of the 3550-3700 MHz band not assigned to a higher tier user and may also operate opportunistically on unused PAL channels.

The PAL systems 304 and GAA systems 306 may be regulated under a Citizens Broadband Radio Service (CBRS). CBSDs (e.g., access points (APs) 102) may only operate under authority of a SAS 308. For example, the CBSD/AP may operate as either a PAL or as a GAA user. Rules are optimized for small-cell use, but also accommodate point-to-point and point-to-multipoint, especially in rural areas.

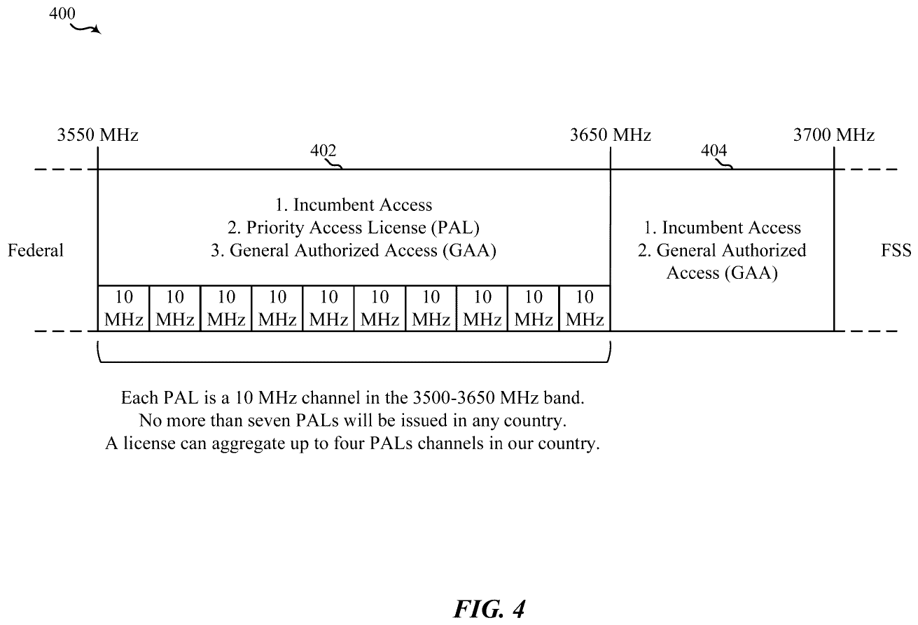

FIG. 4 is a diagram illustrating an example CBRS frequency spectrum 400. As illustrated, the CBRS spectrum is a 150 MHz band in the 3.55-3.7 GHz range. An entity (e.g., an AP) that operates on CBRS band may register and periodically “check-in” with the SAS 308. Private entities can purchase PALs, and each PAL is a 10 MHz channel in the 3500-3650 MHz band. For example, a license can aggregate up to four PAL channels in some countries, but in some cases, a PAL entity cannot lease more than 40 MHz of the PAL spectrum.

In some examples, a network entity may include multiple APs. The multiple APs may coordinate communication scheduling with each other. Each of the multiple APs may form a BSS that overlaps with another BSS. Once a PAL channel is leased, the entity and its multiple APs may gain exclusive rights to the granted spectrum subject to incumbent occupancy. GAA can occupy any remaining portion of the PAL spectrum along with the remaining 80 MHz of the CBRS spectrum.

Aspects of the disclosure are directed to methods and techniques for operating on the 3.5 GHz band in view of the unique rules and characteristics associated with the band.

### Examples of Wi-Fi Operation in a CBRS Spectrum

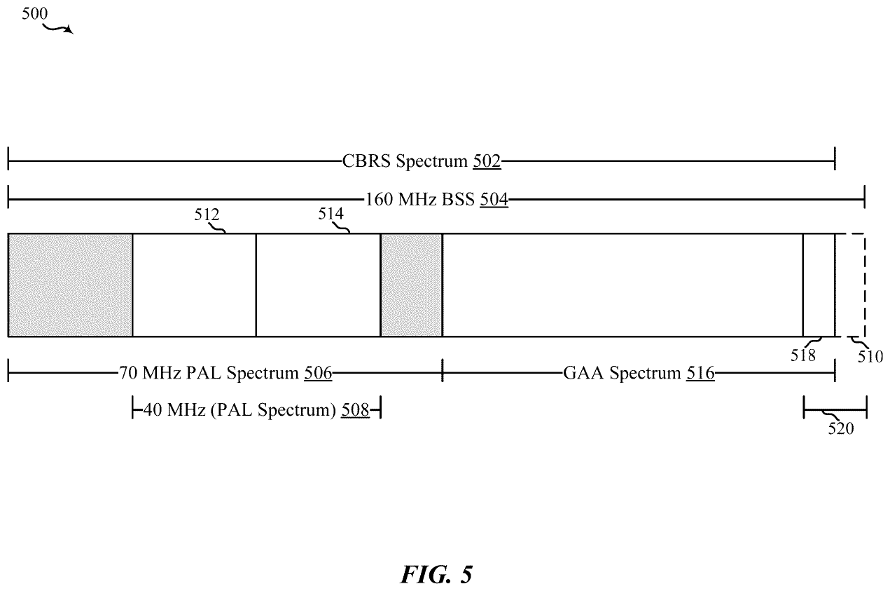

FIG. 5 is a diagram illustrating an example frequency spectrum 500, including a 160 MHz BSS spectrum 504, a CBRS spectrum 502 (e.g., 150 MHz), a PAL spectrum 506 (e.g., 70 MHz— it should be noted that although the PAL spectrum may be broader (e.g., 100 MHz), regulations may limit use of the PAL spectrum to no more than 70 MHz), a GAA spectrum 516 (e.g., 80 MHz), and a first 20 MHz channel 512 and a second 20 MHz channel 514 forming a 40 MHz band reserved by an AP or network entity. It should be noted that the values discussed above are examples, and any suitable values may be used. For example, the bands associated with the first channel 512 and the second channel 514 may be different (e.g., the first channel 512 may be 10 MHz and the second channel 514 may be 15 MHz), or the bands may be the same and less than 20 MHz. Spectrum sizes may also vary.

In certain aspects, an AP communicating within the CBRS spectrum 502 may be configured to setup its primary channel within the PAL spectrum 506. Here the AP may reserve the first channel 512 and the second channel 514, and use either as a primary channel. In this example, the PAL spectrum 506 is 70 MHz, of which 40 MHz is reserved for communications by the AP and its clients. Because the primary channel of the AP is within the PAL spectrum 506, there may be little to no interference from signals transmitted over the GAA spectrum 516 which may include relatively high traffic.

In certain aspects, an AP may be configured to request (e.g., from SAS) no less than 40 MHz of the PAL spectrum 506 for setting up its BSS. In this example, the AP requests the first channel 512 and the second channel 514, for a total of 40 MHz. Thus, only 30 MHz remains available for communication in the PAL spectrum 506. Here, because no less than 40 MHz may be used by an AP, no other AP can request access to the same PAL spectrum 506.

In certain aspects, another AP may request and access a punctured 160 MHz BSS 504. For example, a first AP may request and gain access to 40 MHz of channels (e.g., 40 MHz 508) in the PAL spectrum 506, while a second AP requests one or more channels of the remaining 30 MHz of the PAL spectrum 506 and one or more channels of the GAA spectrum 516. That is, the second AP may communicate over punctured regions of the 160 MHz BSS 504 (e.g., non-contiguous channels). Additional puncturing of the GAA spectrum 516 may be required if any of the remaining 30 MHz in PAL is occupied by other devices (e.g., non-WiFi devices).

In some examples, the first AP or the second AP may update its puncturing pattern if there is any change (e.g., one or more channels used by an AP become unavailable because of an incumbent or other reasons). The SAS can provide information on whether the other 30 is occupied or not (see this). With APs configured to setup a 20 MHz primary channel within the PAL spectrum 506 and request from the SAS no less than 40 MHz within the PAL for its BSS, only one AP will have access to the CBRS spectrum within the PAL spectrum 506. With APs configured to utilize channels within the entire 160 MHz BSS 504, the APs have access to the entire CBRS spectrum 502. As illustrated, the last 20 MHz band 520 of the 160 MHz BSS 504 includes a 10 MHz channel 518 within the CBRS spectrum 502 and a punctured 10 MHz channel 510 adjacent to the CBRS spectrum 502. An AP may be configured to use the last 20 MHz band and/or just the 10 MHz channel 518 within the CBRS spectrum 502.

In certain aspects, multiple APs may be configured to setup a punctured BSS within the 160 MHz BSS 504. In some examples, the multiple APs may be part of the same organization or entity. In such an example, the entity may take ownership of the 40 MHz 508 in the PAL spectrum 506, and the multiple APs may share the same 20 MHz primary channel (e.g., the first channel 512 or the second channel 514). Thus, the BSS associated with each AP may have an overlapping 20 MHz primary. The APs may also have other channels punctured within the 160 MHz BSS 504. The APs may be managed by a separate server or one AP that is configured to coordinate communications via the 20 MHz primary by the other multiple APs. Such coordination may be performed via C-TDMA, C-OFDMA, C-SR formatted communications.

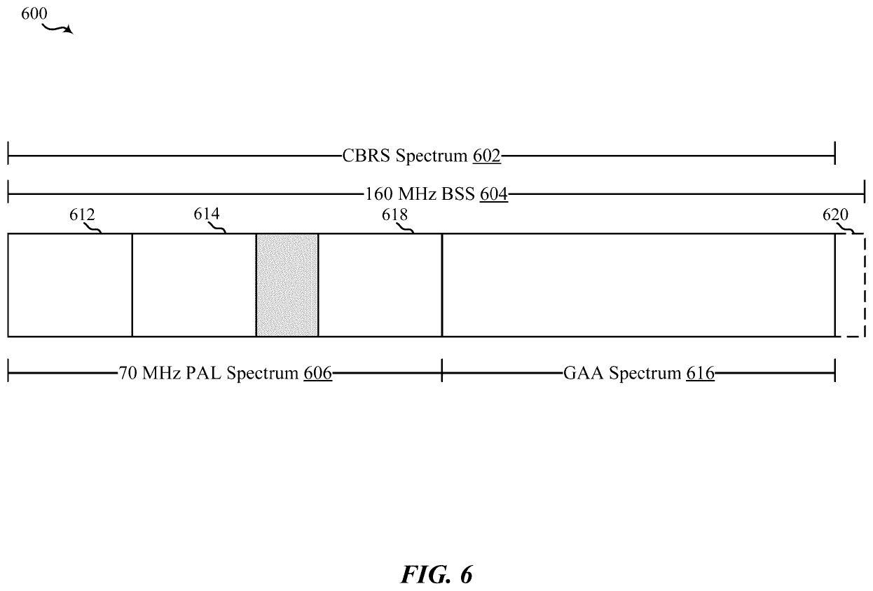

FIG. 6 is a diagram illustrating an example frequency spectrum 600, including a 160 MHz BSS spectrum 604, a CBRS spectrum 602 (e.g., 150 MHz), a PAL spectrum 606 (e.g., 70 MHz— it should be noted that although the PAL spectrum may be broader (e.g., 100 MHz), regulations may limit use of the PAL spectrum to no more than 70 MHz), a GAA spectrum 616 (e.g., 80 MHz), and a first 20 MHz channel 612 used for communication by a first AP, a second 20 MHz channel 614 used for communication by a second AP 614, and a third 20 MHz channel 618 used for communication by a third AP. Thus, the first 20 MHz channel 612 may form all or a portion of the BSS of the first AP, the second 20 MHz channel 614 may form all or a portion of the BSS of the second AP 614, and the third 20 MHz channel 618 may form all or a portion of the BSS of the third AP. It should be noted that the values discussed above are examples, and any suitable values may be used. For example, the bands associated with one or more of the first/second/third channels may be different bandwidths, or the channels may be the same and less than 20 MHz. Spectrum sizes may also vary.

In this example, multiple APs may setup a corresponding BSS within the PAL spectrum 606 and request only 20 MHz within the PAL. As such, the PAL spectrum 606 may support up to three BSSs. Each of the multiple APs may also be configured to setup additional bands puncturing the 160 MHz BSS 604 outside of the PAL spectrum 606. In some examples, the multiple APs may perform coordinated AP (CAP) communications and scheduling to coordinate their transmissions (e.g., C-TDMA, C-OFDMA, C-SR, etc.) One or more of the multiple APs may be independent of each other. In such a case, one of the APs may be a coordination AP configured to schedule and manage communications over bands shared by the multiple APs. Similarly, the multiple APs may all be part of an enterprise or organization. In this example, a server or other centralized entity may manage such communications.

In certain aspects, an AP may use PAL and non-PAL channels for separate communications. That is, an AP may utilize multiple channels of the CBRS spectrum 602 as separate links. In some examples, the AP may utilize a 20 MHz, 15 MHz, or 10 MHz channel for AP-to-AP coordination communications, and AP-to-STA communications. 10 MHZ communications may be performed using suitable formats, including 802.11a (e.g., non-HT) half rate PPDU or 802.11p PPDU.

In certain aspects, an AP may perform power control operations to maintain transmission power with regulatory requirements. In one example, the AP may lower its transmission power to prevent inter-BSS interference and/or maintain a proper level of transmit power. The AP may advertise, to one or more STAs, a maximum allowed transmit power level in its beacon frame or probe response frames to control STA transmission power levels. In some examples, power control may be performed by an operator who has leased channel(s) of the PAL spectrum to setup multiple overlapping or non-overlapping BSSs in a given area and prevent interference between the multiple BSSs. In some examples, multiple APs may be closely located. Thus, the operator and/or the APs may lower their transmit power to reduce the geographic size and coverage of the corresponding BSSs to prevent interference. An AP may also adjust its spectral mask to avoid causing interference into adjust channels within the PAL spectrum that it has not leased.

As discussed, when an incumbent occupies a 3.5 GHz channel, the 3.5 GHz link becomes unavailable for Wi-Fi devices like an AP and STA. For example, a SAS may indicate to the AP that the 3.5 GHz spectrum or channel will be unavailable. Thus, if the 3.5 GHz channel becomes unavailable to the AP and STA, the AP may be limited to communicating the unavailability to the STA via a non-3.5 GHz channel (e.g., 2.4/5/6 GHz channel). In one example, the AP may refrain from transmitting a trigger frame to an STA over the 3.5 GHz channel. Such a refrain may be configured to indicate to the STA that the 3.5 GHz channel is no longer available. In another example, the AP may transmit, to the STA, a beacon frame or a probe configured to indicate that the 3.5 GHz channel is no longer available.

In some examples, an AP MLD could remove or disable an AP communicating over a 3.5 GHz channel. Here, an AP MLD may transmit a frame indicating a timer configured to identify a future time when the 3.5 GHz channel or spectrum will no longer be available (e.g., when the 3.5 GHz AP will be disabled). Alternatively, the frame may include a multi-link reconfiguration configured to disable the 3.5 GHz AP after expiration of a timer. In another example, the AP MLD may transmit a do-not-transmit or link disabled indication via an RNR element to the 3.5 GHz AP.

In some examples, the SAS may transmit an indication of an alternative channel on the 3.5 GHz band to an operator or AP communicating within the PAL spectrum. For example, the AP may receive signaling indicating an alternative 3.5 GHz channel if the current channel is going to be used by an incumbent. In this example, the AP may move its BSS to the alternative channel via multi-link operation (MLO) and/or a channel switch announcement (CSA)/extended CSA (ECSA). Here, the AP may advertise the CSA/ECSA via a per-STA profile of a 3.5 GHz channel on a non-3.5 GHz channel. The AP may advertise the channel switch for a duration of time based for example on a delivery traffic indication message (DTIM) or a listen interval to ensure that all STAs operating on the 3.5 GHz channel receive it.

In certain aspects, rules and regulations for Wi-Fi communications over a 3.5 GHz channel may be used to prevent interference and ensure efficient use of the channel. In one example, all Wi-Fi devices capable of accessing a 3.5 GHz channel may be required to be 802.11bx or later devices (e.g., Greenfield mode devices). 3.5 GHz channel access rules, such as those for target wake time (TWT) and trigger-based (TB) access may be enforced. In another example, an operator may be configured to deploy multiple APs (e.g., AP MLD) such that the BSSs corresponding to each of the APs do not overlap with each other or produce interference.

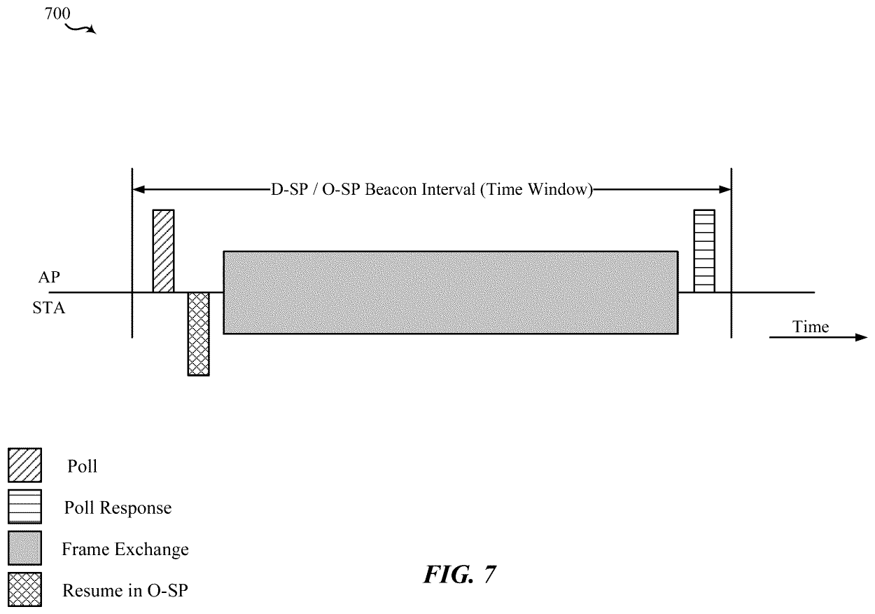

In certain aspects, APs and STAs operating on the 3.5 GHz spectrum may be configured to operate in at least one of multiple modes for communication. In one example, the devices may communicate using a fully scheduled mode, while in another example the devices may communicate using a semi-scheduled mode. FIG. 7 is a block diagram illustrating an example structure 700 of a dedicated service period (D-SP) and opportunistic service period (O-SP) for communication over a 3.5 GHz channel in a fully-scheduled mode. Here, an AP may transmit a poll (e.g., TF) to one or more STAs confirming that the 3.5 GHz channel is available for communication. The one or more STAs may respond to the poll, and the AP and one or more STAs may communicate in a frame exchange. If the frame exchange cannot be completed within the D-SP/O-SP, then the AP may transmit an indication of a future O-SP within which the frame exchange may continue.

3.5 GHz channel access may utilize D-SPs and O-SPs. For example, an AP and STA may negotiate and setup one or more D-SPs on the 3.5 GHz channel for communication. It should be noted that the schedule of service periods (SPs) may be negotiated on a non-3.5 GHz channel (e.g., in case the 3.5 GHz is part of an MLD w/multiple links). A non-AP (e.g., STA) may negotiate more than one SP in a same beacon interval (BI) or window of time according to its traffic profile. In some examples, beacons may be used in the 3.5 GHz spectrum. Accordingly, a window of time (e.g., 100 ms) may be used instead.

The AP may check-in with or query the SAS periodically to confirm the availability of the 3.5 GHz channel. If the 3.5 GHz channel is available for communication, the AP may transmit a TF at the beginning of the D-SP. The TF may be a buffer status report poll (BSRP) or a multi-user request-to-send (MU-RTS) or any other suitable frame configured to poll one or more STAs. The TF may be configured to notify the one or more STAs that the 3.5 GHz is available for communication. It should be noted that a service period (SP) may be shared by multiple STAs; thus, the AP may configure the TF to indicate which STA(s) it intends to serve during a particular SP.

In some examples, the AP may setup one or more O-SPs during ‘gaps’ between scheduled D-SPs. O-SPs may be advertised by the AP to the one or more STAs via non-3.5 GHz channels to help reduce signaling over the 3.5 GHz channel. O-SPs are supplementary to D-SP(s) and may provide additional time to complete a frame exchange that could not be completed during a D-SP. At the end of a D-SP, if the AP has DL buffer units (BUs) for an STA or has received an indication of pending UL BUs at the STA in response to the TF, then the AP may indicate, within the current beacon interval (BI) or time window, an O-SP that the pair can use to resume the frame exchange. An AP may allocate the same O-SP to more than one client and the TF at the beginning of an O-SP may indicate which clients it intends to serve during the O-SP/D-SP.

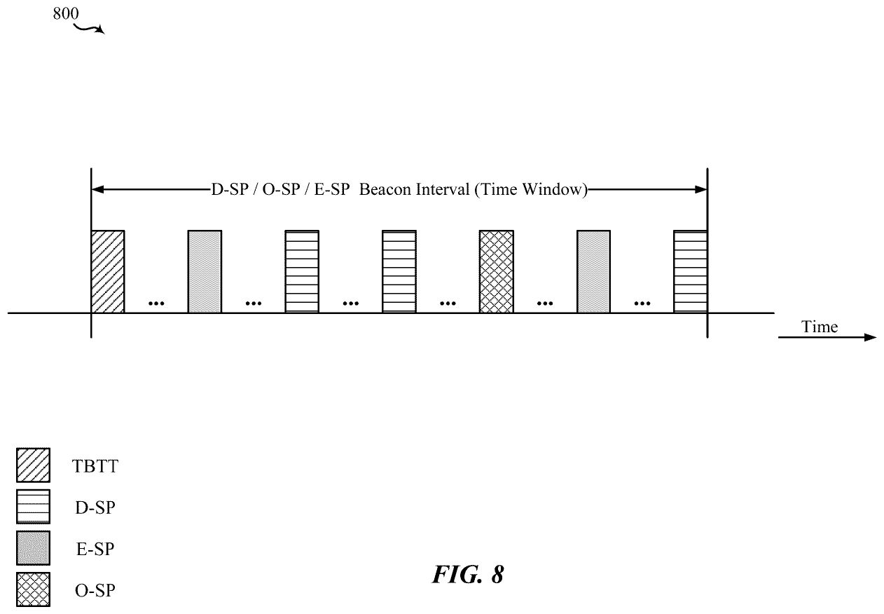

FIG. 8 is a block diagram illustrating an example structure 800 of a dedicated service period (D-SP) and opportunistic service period (O-SP) for communication over a 3.5 GHz channel in a semi-scheduled mode. In addition to the D-SP and O-SP described above, the AP may also setup and schedule one or more EDCA-based service periods (E-SPs) for channel access. During a D-SP and O-SP, the AP's TF may indicate if 3.5 GHz channel is available or not. However, since any device can access the medium during an E-SP, the AP may use singling to indicate whether the 3.5 GHz channel is available.

In one example, the AP may use a beacon frame or probe frame on a non-3.5 GHz link to indicate the status of the 3.5 GHz channel. For example, the frame may indicate whether 3.5 GHz channel access is granted and if so, for how long (e.g., 3.5 GHz channel available for another 15 BIs or time windows). The AP may ping the SAS, update the information based on a response from the SAS, and transmit an updated frame to the STAs. Such signaling may be included for semi-scheduled mode or fully scheduled mode so that STAs can enter into a sleep mode and not wake up on the 3.5 GHz channel if the channel is unavailable.

Certain aspects of the disclosure are directed to 3.5 GHz communications between single-radio or a stand-alone mode devices. For example, Wi-Fi devices that are location-static (e.g., Internet of things (IoT), industrial IoT (IIoT), always associated devices, etc.). In one example, an AP and STA may communicate using rules and techniques to minimize management frames communicated over the 3.5 GHz channel, and instead use non-3.5 GHz channels for onboarding. Here, AP discovery, authentication, and association communications may take place over a non-3.5 GHz band during onboarding. The AP and STA may periodic communicate a keep-alive signal via the 3.5 GHz band to extend the association. Re-discovery and re-association may be allowed in a limited number of SPs of the 3.5 GHz channel to avoid spurious access.

In some examples, a 3.5 GHz STA may operate in a fully scheduled mode where a majority of its communications are uplink transmissions. In such an example, single user (SU) or EDCA uplink access to the 3.5 GHz channel is limited to certain pre-announced duration/service periods. Trigger based access may be allowed during any remaining time.

In some examples, beacon frames may be transmitted infrequently (relative to communications over 2.4/5/6 GHz spectrums). Here, a beacon frame may be transmitted by an AP for maintenance reasons (e.g., timing synchronization function (TSF) updates). However, beacons may be transmitted less often due to BU delivery being performed using scheduled transmissions.

In some examples, an STA may wake up on pre-assigned/dedicated (e.g., TWT) service periods. For example, an AP may add a dynamic, on-demand (e.g., TWT) service period to handle any traffic that spills over from a D-SP (e.g., resume in O-SP of FIG. 7). The AP may also reserve periodic service periods for uplink SU/EDCA access.

In some examples, a stand-alone mode may be vulnerable to incumbent arrival during BSS operations and communications. Here, the disruption can be minimized by switching to the 2.4/5/6 GHz band. Thus, the SAS may notify the AP of an incumbent operating on a 3.5 GHz channel once used by the AP. In response the AP may switch to a non-3.5 GHz channel to resume the BSS operations and communications.

For SA mode operations, an AP may assign TWT service periods for clients to use EDCA for SU PPDU transmission (e.g., E-SP), in addition to the D-SP and O-SP. In this manner, an STA may use E-SP to send unscheduled traffic, management frames etc.

As described above, a TWT may be used by an AP to setup service periods SPs for communication between an AP and one or more STAs. However, in some examples, the AP may use a different type of signals to setup SPs in the 3.5 GHz spectrum. In a first example alternative to TWT, a BI or time window (e.g., BI or time window illustrated in FIGS. 7 and 8) may be divided into X equal size time-blocks (TBs) each of size BI/X. For example, a 100 ms BI may be divided into 80 equal size TBs, making the size of each TB 1.25 ms. Each TB may be identified by a single bit in a 80 bit bitmap (e.g., 80 bits=10 octets). Accordingly, an AP/STA may negotiate and represent their schedules in terms of a 10 octet bitmap. It should be noted that a bitmap size may depend on the size of each TB (e.g., with each bit representing a TB) and the size of BI. Accordingly, the values given above are examples, and any suitable values may be used.

Dividing the BI or time window for channel access in a 3.5 GHz channel may be preferred to a TWT because interference from OB SS may be minimal or not expected (e.g., since the spectrum (at a given region) will be ‘leased’ by a Wi-Fi operator). Also, in-BSS transmissions may be fully scheduled to inform the STA that the 3.5 GHz channel is still available and that the AP intends to serve the STA during the scheduled SP. Thus, dividing the BI or time window may reduce the overhead corresponding to TWT transmissions, and moreover, aspects of the TWT may not be relevant for scheduled access on a 3.5 GHz channel.

In some examples, functionality within a BI is represented in terms of TB. For example: 2 TBs for TBTT (e.g., beacon transmission), where the rest of the time in a BI is allocated to STAs based on their traffic needs (D-SPs and O-SPs). The AP may transmit a beacon frame in a non-3.5 GHz link, wherein the beacon frame is configured to carry a bitmap indicating which TBs are available or in use (e.g., 0 or 1). An STA may negotiate on the non-3.5 GHz link to add or remove TBs, and the STA may request to add blocks if the bit position indicated 0. The STA may transmit the request to the AP, and the AP may accept/deny the request, and/or propose an alternative. Thus, a communication schedule may be announced in non-3.5 GHz links with each bit set to 1 for a slot that is allocated.

In some examples, the 3.5 GHz AP is part of an AP MLD that includes multiple APs operating on non-3.5 GHz bands. Here, each AP of the AP MLD may be required to satisfying certain criteria before it is allowed to communicate over a 3.5 GHz channel as part of a multi-link association with the AP MLD. Here, an RNR element may be configured to indicate such requirements (e.g., X amount of time on the 3.5 GHz band can be purchased for a specific amount of currency) and/or a multi-link probe response may provide a condition or criteria to be satisfied. When the necessary conditions are met by the AP, the 3.5 GHz channel can be added to an existing multi-link association via a ML reconfiguration “add” operation. Similarly, the 3.5 GHz channel may removed from an existing multi-link setup via a multi-link reconfiguration “delete” operation when criteria are no longer satisfied (e.g., paid access to the 3.5 GHz link for a specific amount of time (e.g., gaming arcade), and the time has expired).

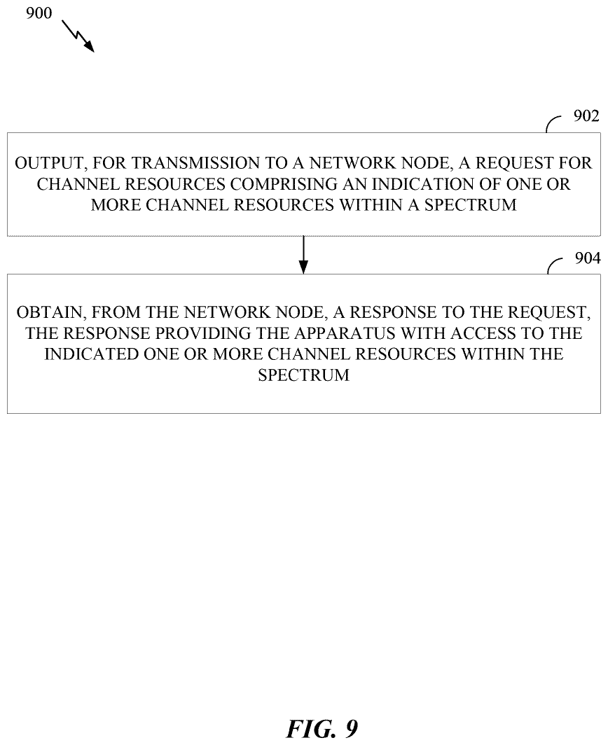

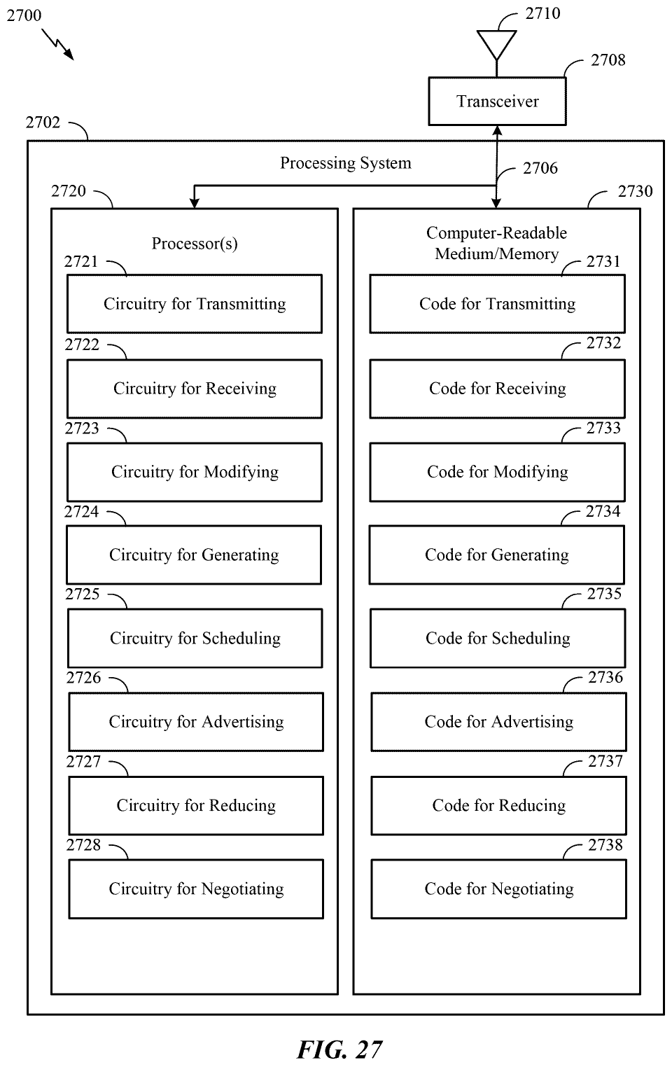

FIG. 9 is a flow diagram illustrating an example method 900 of wireless communication, by such as via execution of components (including by processor 2720 and/or memory 2730) illustrated in FIG. 27.

At block 902, the method 900 includes outputting, for transmission to a network node, a request for channel resources comprising an indication of one or more channel resources within a spectrum. For example, in an aspect, processing system 2702, processor 2720, memory 2730, circuitry for transmitting 2721, and/or code for transmitting 2731 may be configured to or may comprise means for outputting, for transmission to a network node, a request for channel resources comprising an indication of one or more channel resources within a spectrum.

At block 904, the method includes obtaining, from the network node, a response to the request, the response providing the apparatus with access to the indicated one or more channel resources within the spectrum. For example, in an aspect, processing system 2702, processor 2720, memory 2730, circuitry for receiving 2722, and/or code for receiving 2732 may be configured to or may comprise means for obtaining, from the network node, a response to the request, the response providing the apparatus with access to the indicated one or more channel resources within the spectrum.

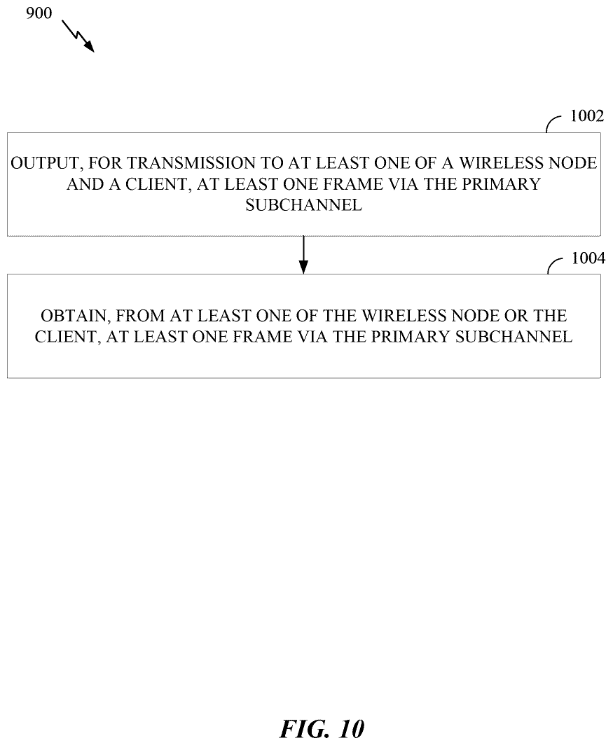

FIG. 10 is a flow diagram illustrating alternative of additional aspects of the example method 900 of wireless communication, by such as via execution of components (including by processor 2720 and/or memory 2730) illustrated in FIG. 27. At block 1002, the method 900 includes outputting, for transmission to at least one of a wireless node or a client, at least one first frame via the primary subchannel. For example, in an aspect, processing system 2702, processor 2720, memory 2730, circuitry for transmitting 2721, and/or code for transmitting 2731 may be configured to or may comprise means for outputting, for transmission to at least one of a wireless node or a client, at least one first frame via the primary subchannel.

At block 1004, the method includes obtaining, from at least one of the wireless node or the client, at least one second frame via the primary subchannel. For example, in an aspect, processing system 2702, processor 2720, memory 2730, circuitry for receiving 2722, and/or code for receiving 2732 may be configured to or may comprise means for obtaining, from at least one of the wireless node or the client, at least one second frame via the primary subchannel.

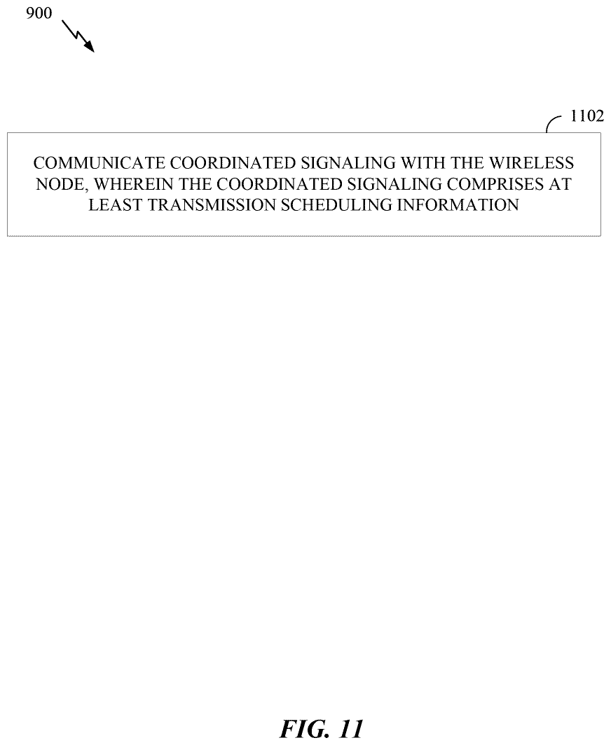

FIG. 11 is a flow diagram illustrating alternative of additional aspects of the example method 900 of wireless communication, by such as via execution of components (including by processor 2720 and/or memory 2730) illustrated in FIG. 27. At block 1102, the method 900 includes communicating coordinated signaling with the wireless node, wherein the coordinated signaling comprises transmission scheduling information. For example, in an aspect, processing system 2702, processor 2720, memory 2730, circuitry for transmitting 2721, circuitry for receiving 2722, code for receiving 2732, and/or code for transmitting 2731 may be configured to or may comprise means for communicating coordinated signaling with the wireless node, wherein the coordinated signaling comprises transmission scheduling information.

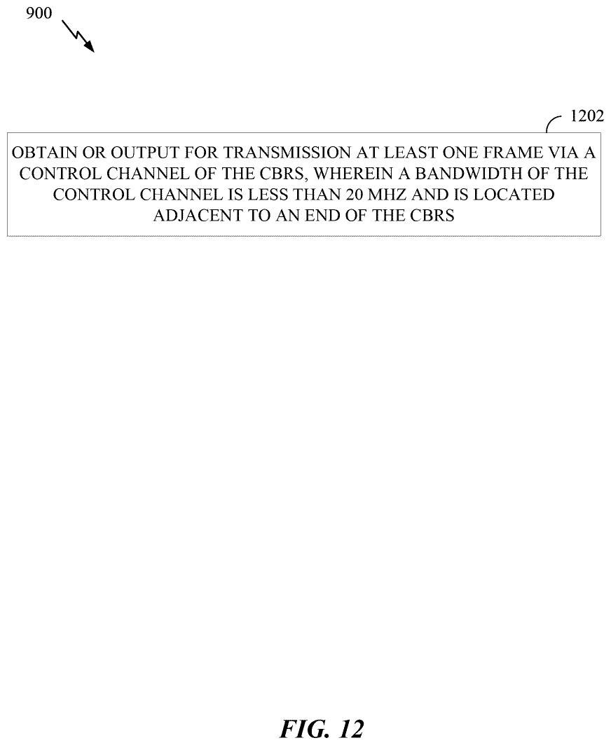

FIG. 12 is a flow diagram illustrating alternative of additional aspects of the example method 900 of wireless communication, by such as via execution of components (including by processor 2720 and/or memory 2730) illustrated in FIG. 27. At block 1202, the method 900 includes obtaining or output for transmission at least one frame via a control channel of the CBRS, wherein a bandwidth of the control channel is less than 20 MHz and is located adjacent to an end of the CBRS. For example, in an aspect, processing system 2702, processor 2720, memory 2730, circuitry for receiving 2722, and/or code for receiving 2732 may be configured to or may comprise means for obtaining or output for transmission at least one frame via a control channel of the CBRS, wherein a bandwidth of the control channel is less than 20 MHz and is located adjacent to an end of the CBRS.

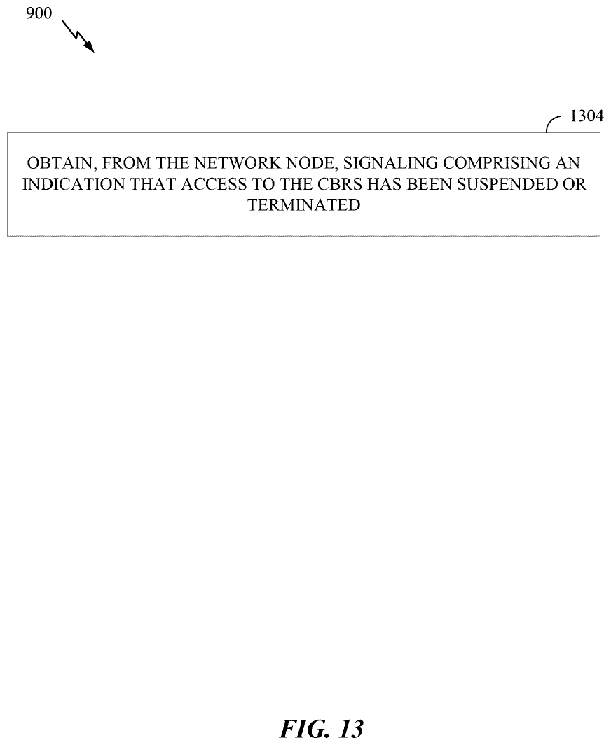

FIG. 13 is a flow diagram illustrating alternative of additional aspects of the example method 900 of wireless communication, by such as via execution of components (including by processor 2720 and/or memory 2730) illustrated in FIG. 27. At block 1302, the method 900 includes obtaining, from the network node, signaling comprising an indication that access to the CBRS has been suspended or terminated. For example, in an aspect, processing system 2702, processor 2720, memory 2730, circuitry for receiving 2722, and/or code for receiving 2732 may be configured to or may comprise means for obtain, from the network node, signaling comprising an indication that access to the CBRS has been suspended or terminated.

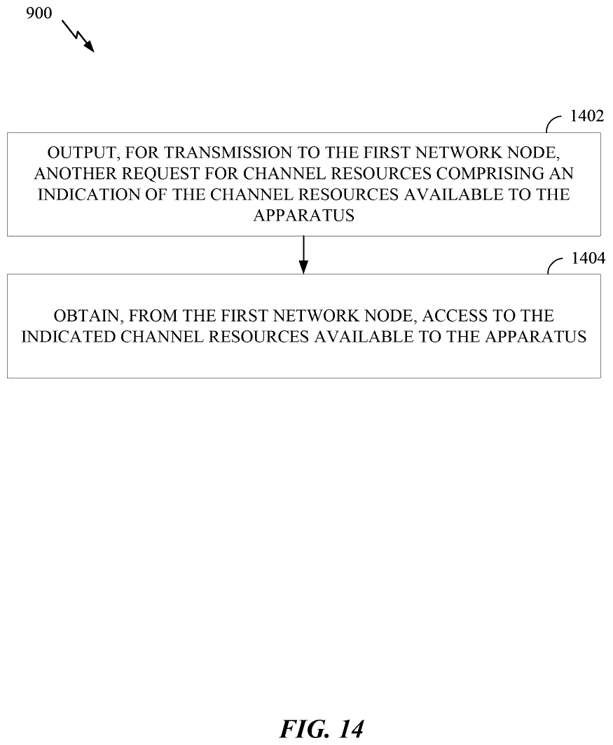

FIG. 14 is a flow diagram illustrating alternative of additional aspects of the example method 900 of wireless communication, by such as via execution of components (including by processor 2720 and/or memory 2730) illustrated in FIG. 27. At block 1402, the method 900 includes outputting, for transmission to the network node, another request for channel resources comprising an indication of the channel resources available to the apparatus. For example, in an aspect, processing system 2702, processor 2720, memory 2730, circuitry for transmitting 2721, and/or code for transmitting 2731 may be configured to or may comprise means for outputting, for transmission to the network node, another request for channel resources comprising an indication of the channel resources available to the apparatus.

At block 1404, the method 900 includes obtaining, from the network node, access to the indicated channel resources available to the apparatus. For example, in an aspect, processing system 2702, processor 2720, memory 2730, circuitry for receiving 2722, and/or code for receiving 2732 may be configured to or may comprise means for obtaining, from the network node, access to the indicated channel resources available to the apparatus.

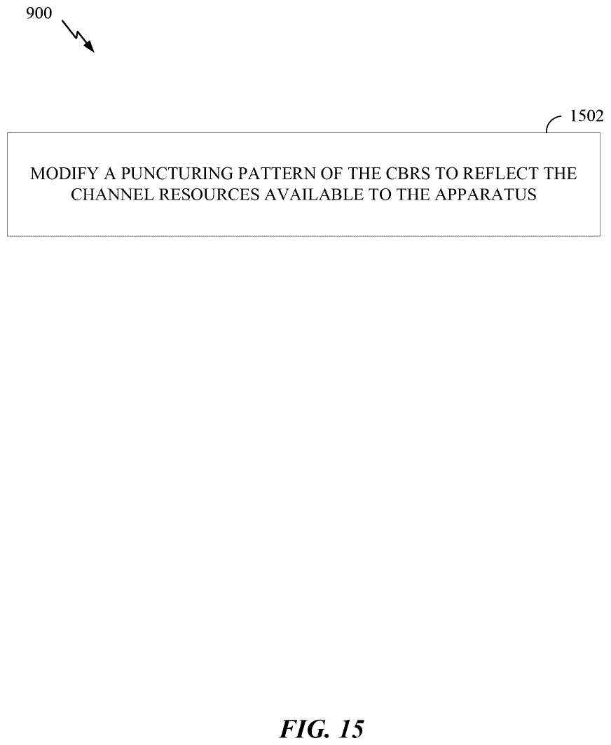

FIG. 15 is a flow diagram illustrating alternative of additional aspects of the example method 900 of wireless communication, by such as via execution of components (including by processor 2720 and/or memory 2730) illustrated in FIG. 27. At block 1502, the method 900 includes modifying a puncturing pattern of the CBRS to reflect the channel resources available to the apparatus. For example, in an aspect, processing system 2702, processor 2720, memory 2730, circuitry for modifying 2723, and/or code for modifying 2733 may be configured to or may comprise means for modifying a puncturing pattern of the CBRS to reflect the channel resources available to the apparatus.

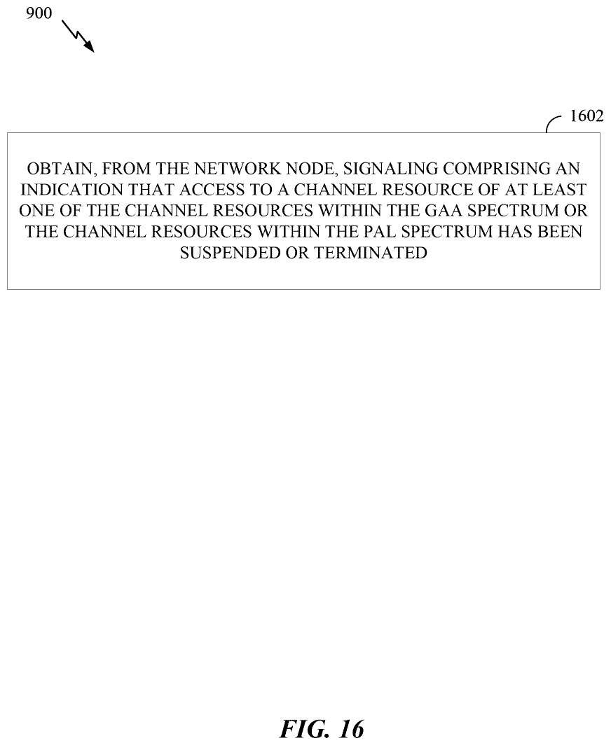

FIG. 16 is a flow diagram illustrating alternative of additional aspects of the example method 900 of wireless communication, by such as via execution of components (including by processor 2720 and/or memory 2730) illustrated in FIG. 27. At block 1602, the method 900 includes obtaining, from the network node, signaling comprising an indication that access to a channel resource of at least one of the channel resources within the GAA spectrum or the channel resources within the PAL spectrum has been suspended or terminated. For example, in an aspect, processing system 2702, processor 2720, memory 2730, circuitry for receiving 2722, and/or code for receiving 2732 may be configured to or may comprise means for obtaining, from the network node, signaling comprising an indication that access to a channel resource of at least one of the channel resources within the GAA spectrum or the channel resources within the PAL spectrum has been suspended or terminated.

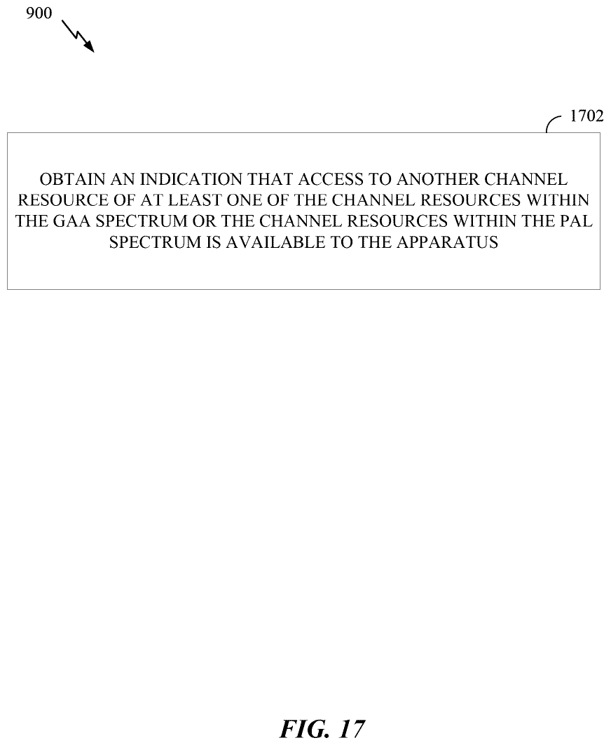

FIG. 17 is a flow diagram illustrating alternative of additional aspects of the example method 900 of wireless communication, by such as via execution of components (including by processor 2720 and/or memory 2730) illustrated in FIG. 27. At block 1702, the method 900 includes obtaining an indication that access to another channel resource of at least one of the channel resources within the GAA spectrum or the channel resources within the PAL spectrum is available to the apparatus. For example, in an aspect, processing system 2702, processor 2720, memory 2730, circuitry for receiving 2722, and/or code for receiving 2732 may be configured to or may comprise means for obtaining an indication that access to another channel resource of at least one of the channel resources within the GAA spectrum or the channel resources within the PAL spectrum is available to the apparatus.

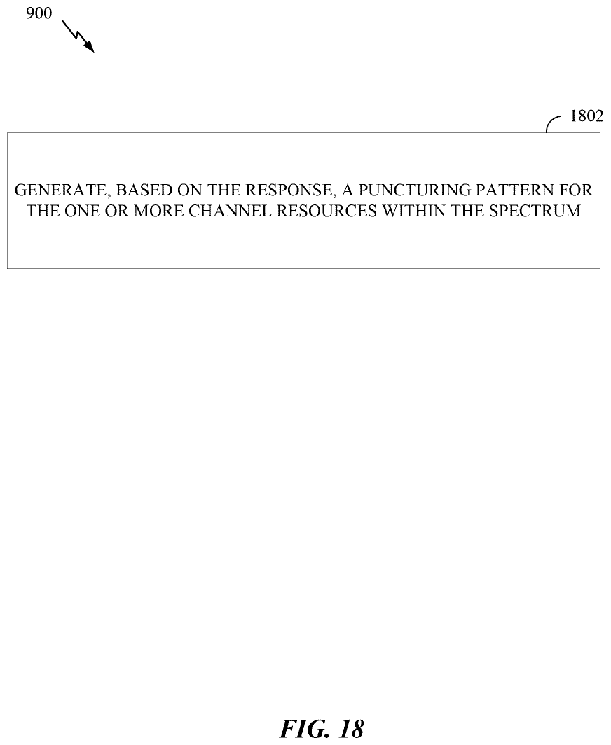

FIG. 18 is a flow diagram illustrating alternative of additional aspects of the example method 900 of wireless communication, by such as via execution of components (including by processor 2720 and/or memory 2730) illustrated in FIG. 27. At block 1802, the method 900 includes generating, based on the response, a puncturing pattern for the one or more channel resources within the spectrum. For example, in an aspect, processing system 2702, processor 2720, memory 2730, circuitry for generating 2724, and/or code for generating 2734 may be configured to or may comprise means for generating, based on the response, a puncturing pattern for the one or more channel resources within the spectrum.

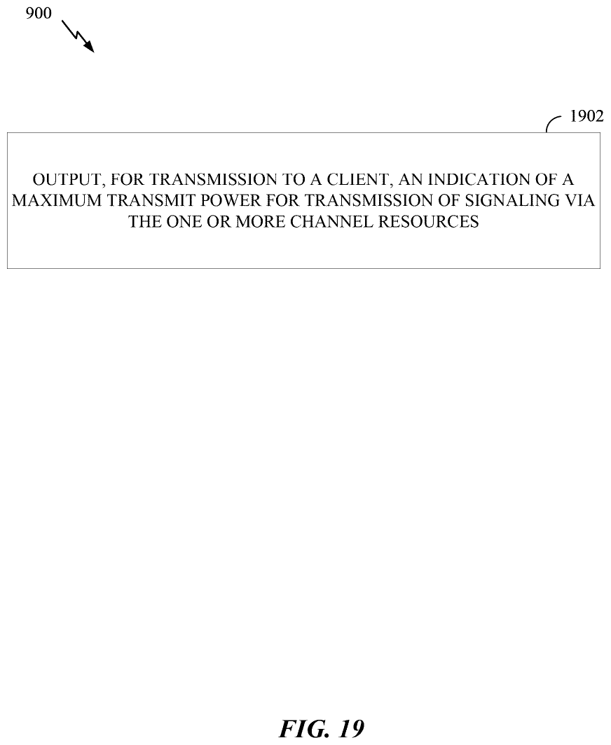

FIG. 19 is a flow diagram illustrating alternative of additional aspects of the example method 900 of wireless communication, by such as via execution of components (including by processor 2720 and/or memory 2730) illustrated in FIG. 27. At block 1902, the method 900 includes outputting, for transmission to a client, an indication of a maximum transmit power for transmission of signaling via the one or more channel resources. For example, in an aspect, processing system 2702, processor 2720, memory 2730, circuitry for transmitting 2721, and/or code for transmitting 2731 may be configured to or may comprise means for outputting, for transmission to a client, an indication of a maximum transmit power for transmission of signaling via the one or more channel resources.

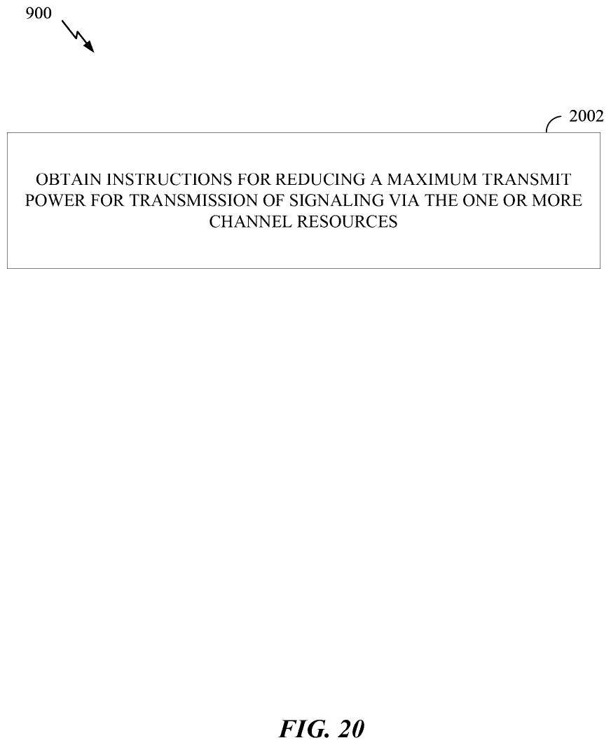

FIG. 20 is a flow diagram illustrating alternative of additional aspects of the example method 900 of wireless communication, by such as via execution of components (including by processor 2720 and/or memory 2730) illustrated in FIG. 27. At block 2002, the method 900 includes obtaining instructions for reducing a maximum transmit power for transmission of signaling via the one or more channel resources. For example, in an aspect, processing system 2702, processor 2720, memory 2730, circuitry for receiving 2722, and/or code for receiving 2732 may be configured to or may comprise means for obtaining instructions for reducing a maximum transmit power for transmission of signaling via the one or more channel resources.

At block 2004, the method 900 includes reducing the maximum transmit power based on the instructions. For example, in an aspect, processing system 2702, processor 2720, memory 2730, circuitry for reducing 2727, and/or code for reducing 2737 may be configured to or may comprise means for reducing the maximum transmit power based on the instructions.

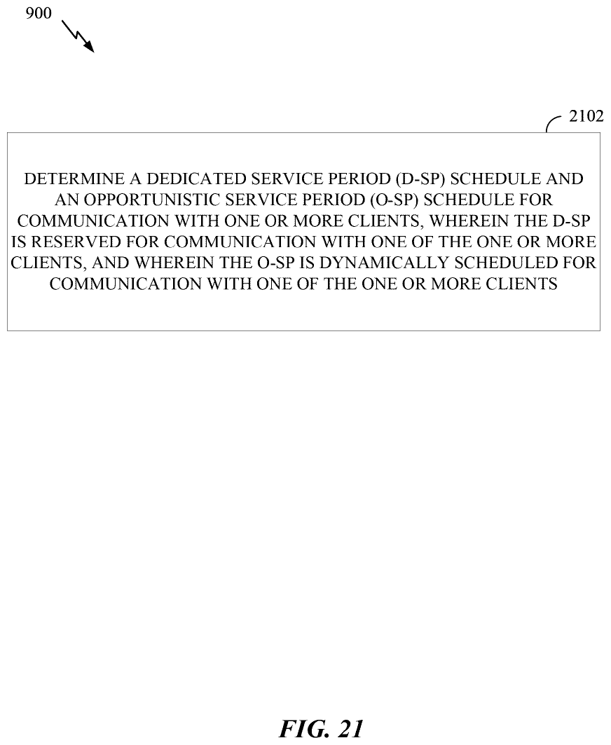

FIG. 21 is a flow diagram illustrating alternative of additional aspects of the example method 900 of wireless communication, by such as via execution of components (including by processor 2720 and/or memory 2730) illustrated in FIG. 27. At block 2102, the method 900 includes scheduling a dedicated service period (D-SP) and an opportunistic service period (O-SP) for communication with one or more clients, wherein the D-SP is reserved for communication with one of the one or more clients, and wherein the O-SP is dynamically scheduled for communication with one of the one or more clients. For example, in an aspect, processing system 2702, processor 2720, memory 2730, circuitry for scheduling 2725, and/or code for scheduling 2735 may be configured to or may comprise means for scheduling a dedicated service period (D-SP) and an opportunistic service period (O-SP) for communication with one or more clients, wherein the D-SP is reserved for communication with one of the one or more clients, and wherein the O-SP is dynamically scheduled for communication with one of the one or more clients.

At block 2104, the method 900 includes communicating with the one or more clients via the D-SP and O-SP. For example, in an aspect, processing system 2702, processor 2720, memory 2730, circuitry for transmitting 2721, code for transmitting 2731, circuitry for receiving 2722, and/or code for receiving 2732 may be configured to or may comprise means for communicating with the one or more clients via the D-SP and O-SP.

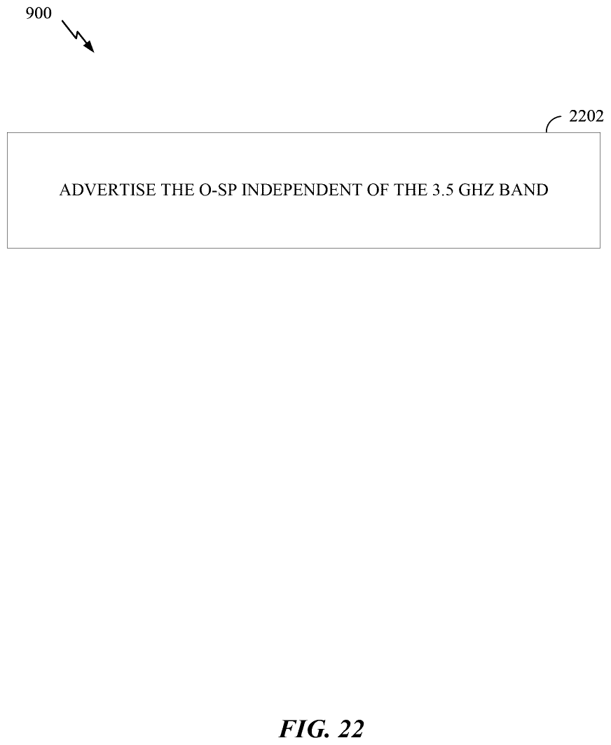

FIG. 22 is a flow diagram illustrating alternative of additional aspects of the example method 900 of wireless communication, by such as via execution of components (including by processor 2720 and/or memory 2730) illustrated in FIG. 27. At block 2202, the method 900 includes advertising the O-SP independent of the 3.5 GHz band. For example, in an aspect, processing system 2702, processor 2720, memory 2730, circuitry for advertising 2726, and/or code for advertising 2736 may be configured to or may comprise means for advertising the O-SP independent of the 3.5 GHz band.

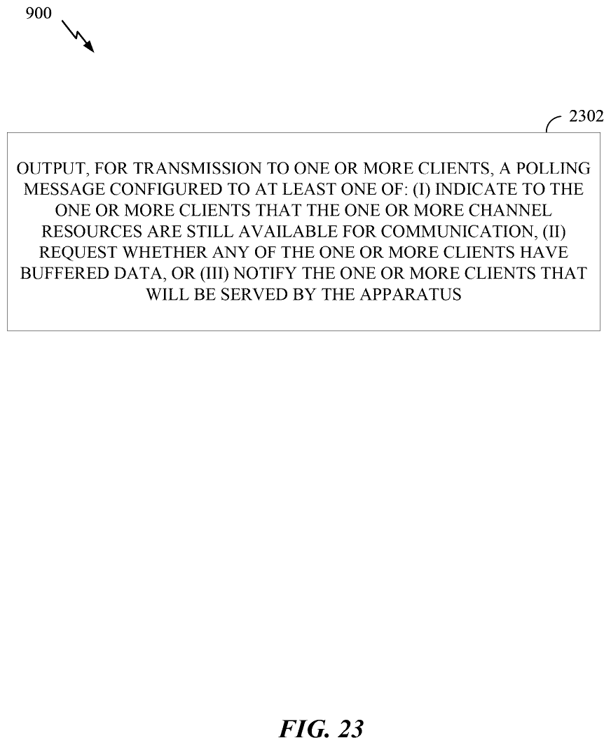

FIG. 23 is a flow diagram illustrating alternative of additional aspects of the example method 900 of wireless communication, by such as via execution of components (including by processor 2720 and/or memory 2730) illustrated in FIG. 27. At block 2302, the method 900 includes outputting, for transmission to one or more clients, a polling message configured to at least one of: (i) indicate to the one or more clients that the one or more channel resources are still available for communication, (ii) request whether any of the one or more clients have buffered data, or (iii) notify the one or more clients that will be served by the apparatus. For example, in an aspect, processing system 2702, processor 2720, memory 2730, circuitry for transmitting 2721, and/or code for transmitting 2731 may be configured to or may comprise means for outputting, for transmission to one or more clients, a polling message configured to at least one of: (i) indicate to the one or more clients that the one or more channel resources are still available for communication, (ii) request whether any of the one or more clients have buffered data, or (iii) notify the one or more clients that will be served by the apparatus.

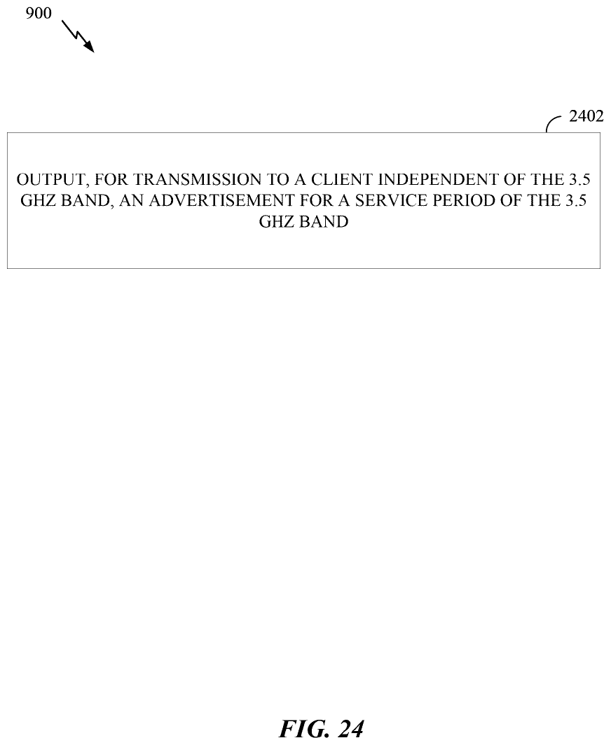

FIG. 24 is a flow diagram illustrating alternative of additional aspects of the example method 900 of wireless communication, by such as via execution of components (including by processor 2720 and/or memory 2730) illustrated in FIG. 27. At block 2402, the method 900 includes outputting, for transmission independent of the 3.5 GHz band, an advertisement for a service period of the 3.5 GHz band. For example, in an aspect, processing system 2702, processor 2720, memory 2730, circuitry for transmitting 2721, and/or code for transmitting 2731 may be configured to or may comprise means for outputting, for transmission independent of the 3.5 GHz band, an advertisement for a service period of the 3.5 GHz band.

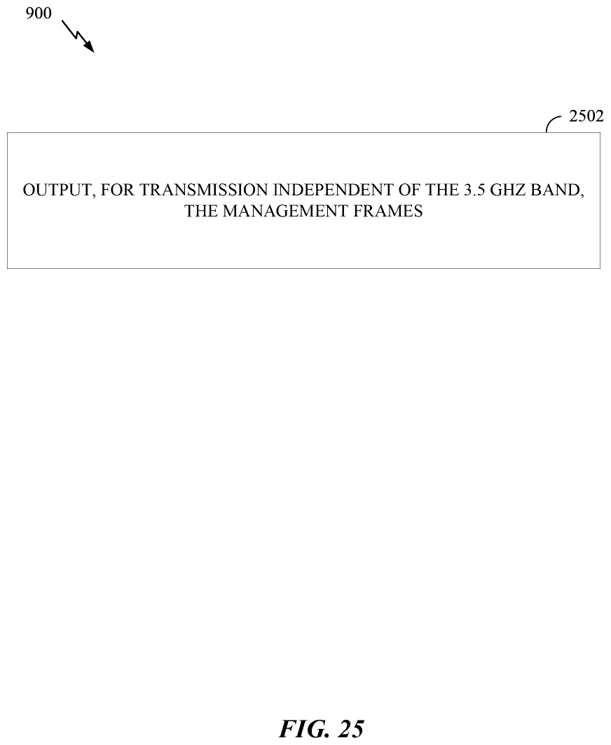

FIG. 25 is a flow diagram illustrating alternative of additional aspects of the example method 900 of wireless communication, by such as via execution of components (including by processor 2720 and/or memory 2730) illustrated in FIG. 27. At block 2502, the method 900 includes outputting, for transmission independent of the 3.5 GHz band, the management frames. For example, in an aspect, processing system 2702, processor 2720, memory 2730, circuitry for transmitting 2721, and/or code for transmitting 2731 may be configured to or may comprise means for outputting, for transmission independent of the 3.5 GHz band, the management frames.

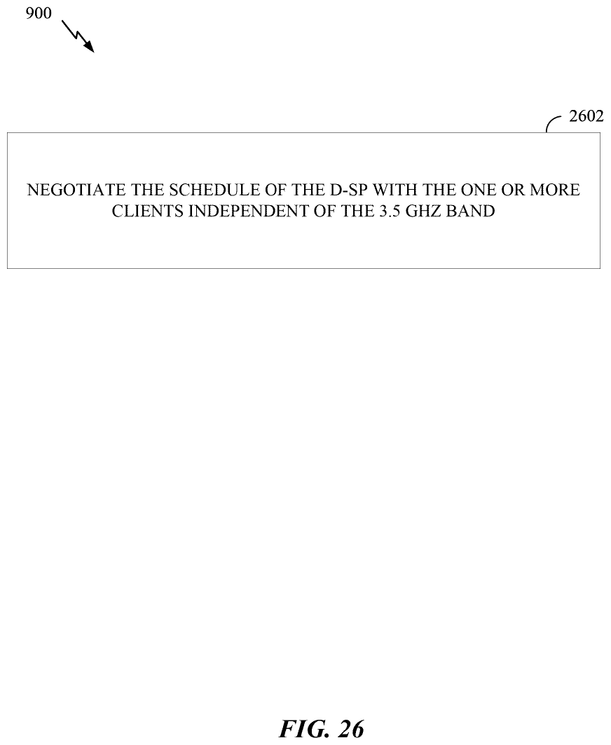

FIG. 26 is a flow diagram illustrating alternative of additional aspects of the example method 900 of wireless communication, by such as via execution of components (including by processor 2720 and/or memory 2730) illustrated in FIG. 27. At block 2602, the method 900 includes negotiating the schedule of the D-SP with the one or more clients independent of the 3.5 GHz band. For example, in an aspect, processing system 2702, processor 2720, memory 2730, circuitry for negotiating 2728, and/or code for negotiating 2738 may be configured to or may comprise means for negotiating the schedule of the D-SP with the one or more clients independent of the 3.5 GHz band.

Referring to FIGS. 9-26, in certain aspects, the indicated one or more channel resources comprise a primary subchannel.

In certain aspects, the one or more channel resources are associated with 40 MHz or higher bandwidth, and wherein the spectrum is a 70 MHz band.

In certain aspects, the spectrum is a 70 MHz priority access license (PAL) spectrum, wherein a citizen broadband radio spectrum (CBRS) contains the PAL spectrum and a general authorized access (GAA) spectrum, wherein the request for channel resources further comprises an indication of channel resources within the GAA spectrum, and wherein the response to the request further provides the apparatus access to one or more of the indicated channel resources within the GAA spectrum.

In certain aspects, a physical layer protocol data unit (PPDU) of the at least one frame is formatted by using an 802.11a half-rate PPDU or an 802.11p PPDU.

In certain aspects, the indicated one or more channel resources within the PAL spectrum and the indicated channel resources within the GAA spectrum form an operating bandwidth of a basic service set (BSS) of the apparatus.

In certain aspects, a granularity of the puncturing pattern is given in chunks of 5 MHz, 10 MHZ, or 15 MHz.

In certain aspects, at least one of a reduced neighbor report (RNR) or a multi-link probe response comprises the indication.

In certain aspects, the response further provides the apparatus access to one or more channel resources within a general authorized access (GAA) spectrum, and wherein the puncturing pattern is generated also for the one or more channel resources within the GAA spectrum.

In certain aspects, the one or more channel resources are associated with 20 MHz or higher of bandwidth.

In certain aspects, the one or more channel resources are within a 3.5 GHz band, and wherein the one or more processors are further configured to cause the apparatus to: negotiate the schedule of the D-SP with the one or more clients independent of the 3.5 GHz band.

In certain aspects, the one or more channel resources are within a 3.5 GHz band.

In certain aspects, one or more of the D-SP and the O-SP are indicated via a target wake up time (TWT).

In certain aspects, one or more of the D-SP and the O-SP are indicated via a bitmap.

In certain aspects, each bit in the bitmap is configured to identify a time block corresponding to the D-SP or the O-SP, and wherein the bitmap is further configured to one or more of advertise, request, and grant one or more time blocks.

In certain aspects, the one or more channel resources are within a 3.5 GHz band, wherein management frames are configured for at least one of discovery, authentication, or association with the 3.5 GHz band.

FIG. 27 illustrates a communications device 2700 that may include various components (e.g., corresponding to means-plus-function components) configured to perform operations for the techniques disclosed herein, such as the operations illustrated in FIGS. 9-26. The communications device 2700 includes a processing system 2702 coupled to a transceiver 2708 (e.g., a transmitter and/or a receiver). The transceiver 2708 is configured to transmit and receive signals for the communications device 2700 via an antenna 2710, such as the various signals as described herein. The processing system 2702 may be configured to perform processing functions for the communications device 2700, including processing signals received and/or to be transmitted by the communications device 2700.

The processing system 2702 includes a processor 2704 coupled to a computer-readable medium/memory 2712 via a bus 2706. In certain aspects, the computer-readable medium/memory 2712 is configured to store instructions (e.g., computer-executable code) that when executed by the processor 2704, cause the processor 2704 to perform the operations illustrated in FIGS. 9-26, or other operations for performing the various techniques discussed herein.

Means for transmitting, means for communicating, or means for receiving may include a transceiver (such as the receive processor 242, transmit processor 220, modulators 222, and/or antenna 224) and/or an antenna(s) 320 of the AP 102 illustrated in FIG. 2.

Means for modifying and means for determining may include a processor (such as the transmit data processor 210, the receive data processor 242, the controller 230, and/or the scheduler 234) of the AP 102 illustrated in FIG. 2.

Means for advertising may include a transceiver (such as the receive processor 242, transmit processor 220, modulators 222, and/or antenna 224) and/or an antenna(s) 320 of the AP 102 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Example Aspects

Example 1 is a method for wireless communication at an apparatus, comprising: outputting, for transmission to a network node, a request for channel resources comprising an indication of one or more channel resources within a spectrum; and obtaining, from the network node, a response to the request, the response providing the apparatus with access to the indicated one or more channel resources within the spectrum.

Example 2 is the method of example 1, wherein the indicated one or more channel resources comprise a primary subchannel, and wherein the method further comprises: outputting, for transmission to at least one of a wireless node or a client, at least one first frame via the primary subchannel; and obtaining, from at least one of the wireless node or the client, at least one second frame via the primary subchannel.

Example 3 is the method of example 2, wherein the method further comprises: communicating coordinated signaling with the wireless node, wherein the coordinated signaling comprises transmission scheduling information.

Example 4 is the method of any of examples 1-3, wherein the one or more channel resources are associated with 40 MHz or higher bandwidth, and wherein the spectrum is a 70 MHz band.

Example 5 is the method of any of examples 1-4, wherein the spectrum is a 70 MHz priority access license (PAL) spectrum, wherein a citizen broadband radio spectrum (CBRS) contains the PAL spectrum and a general authorized access (GAA) spectrum, wherein the request for channel resources further comprises an indication of channel resources within the GAA spectrum, and wherein the response to the request further provides the apparatus access to one or more of the indicated channel resources within the GAA spectrum.

Example 6 is the method of example 5, wherein the method further comprises: obtaining or outputting for transmission at least one frame via a control channel of the CBRS, wherein a bandwidth of the control channel is less than 20 MHz and is located adjacent to an end of the CBRS.

Example 7 is the method of example 6, wherein a physical layer protocol data unit (PPDU) of the at least one frame is formatted by using an 802.11a half-rate PPDU or an 802.11p PPDU.

Example 8 is the method of example 5, wherein the indicated one or more channel resources within the PAL spectrum and the indicated channel resources within the GAA spectrum form an operating bandwidth of a basic service set (BSS) of the apparatus.

Example 9 is the method of example 5, wherein the method further comprises: obtaining, from the network node, signaling comprising an indication that access to the CBRS has been suspended or terminated.

Example 10 is the method of example 9, wherein the method further comprises: outputting, for transmission to the network node, another request for channel resources comprising an indication of the channel resources available to the apparatus; and obtaining, from the network node, access to the indicated channel resources available to the apparatus.

Example 11 is the method of example 10, wherein the method further comprises: modifying a puncturing pattern of the CBRS to reflect the channel resources available to the apparatus.

Example 12 is the method of example 11, wherein a granularity of the puncturing pattern is given in chunks of 5 MHz, 10 MHZ, or 15 MHz.

Example 13 is the method of example 5, wherein the method further comprises: obtaining, from the network node, signaling comprising an indication that access to a channel resource of at least one of the channel resources within the GAA spectrum or the channel resources within the PAL spectrum has been suspended or terminated.

Example 14 is the method of example 13, wherein the method further comprises: obtaining an indication that access to another channel resource of at least one of the channel resources within the GAA spectrum or the channel resources within the PAL spectrum is available to the apparatus.

Example 15 is the method of example 14, wherein at least one of a reduced neighbor report (RNR) or a multi-link probe response comprises the indication.

Example 16 is the method of any of examples 1-15, wherein the method further comprises: generating, based on the response, a puncturing pattern for the one or more channel resources within the spectrum.

Example 17 is the apparatus of example 16, wherein the response further provides the apparatus access to one or more channel resources within a general authorized access (GAA) spectrum, and wherein the puncturing pattern is generated also for the one or more channel resources within the GAA spectrum.

Example 18 is the method of any of examples 17 wherein the one or more channel resources are associated with 20 MHz or higher of bandwidth.

Example 19 is the method of any of examples 1-19, wherein the method further comprises: outputting, for transmission to a client, an indication of a maximum transmit power for transmission of signaling via the one or more channel resources.

Example 20 is the method of any of examples 1-19, wherein the method further comprises: obtaining instructions for reducing a maximum transmit power for transmission of signaling via the one or more channel resources; and reducing the maximum transmit power based on the instructions.

Example 21 is the method of any of examples 1-20, wherein the method further comprises: scheduling a dedicated service period (D-SP) and an opportunistic service period (O-SP) for communication with one or more clients, wherein the D-SP is reserved for communication with one of the one or more clients, and wherein the O-SP is dynamically scheduled for communication with one of the one or more clients; and communicating with the one or more clients via the D-SP and O-SP.

Example 22 is the method of example 21, wherein the one or more channel resources are within a 3.5 GHz band, and wherein the one or more processors are further configured to cause the apparatus to: negotiate the schedule of the D-SP with the one or more clients independent of the 3.5 GHz band.

Example 23 is the method of example 21, wherein the one or more channel resources are within a 3.5 GHz band, and wherein the method further comprises: advertising the O-SP independent of the 3.5 GHz band.

Example 24 is the method of example 21, wherein one or more of the D-SP and the O-SP are indicated via a target wake up time (TWT).

Example 25 is the method of example 21, wherein one or more of the D-SP and the O-SP are indicated via a bitmap.

Example 26 is the method of example 25, wherein each bit in the bitmap is configured to identify a time block corresponding to the D-SP or the O-SP, and wherein the bitmap is further configured to one or more of advertise, request, and grant one or more time blocks.

Example 27 is the method of any of examples 1-26, wherein the method further comprises: outputting, for transmission to one or more clients, a polling message configured to at least one of: (i) indicate to the one or more clients that the one or more channel resources are still available for communication, (ii) request whether any of the one or more clients have buffered data, or (iii) notify the one or more clients that will be served by the apparatus.

Example 28 is the method of example 27, wherein at least one of: the polling message is output for transmission at a start of a service period; or the polling message is a trigger frame.

Example 29 is the method of any of examples 1-28, wherein the one or more channel resources are within a 3.5 GHz band, and wherein the method further comprises: outputting, for transmission independent of the 3.5 GHz band, an advertisement for a service period of the 3.5 GHz band.

Example 30 is the method of any of examples 1-29, wherein the one or more channel resources are within a 3.5 GHz band, wherein management frames are configured for at least one of discovery, authentication, or association with the 3.5 GHz band, and wherein the method further comprises: outputting, for transmission independent of the 3.5 GHz band, the management frames.

Example 31 is an apparatus for wireless communications, comprising means for performing a method in accordance with any one of examples 1-30.

Example 32 is a non-transitory computer-readable medium comprising instructions that, when executed by an apparatus, cause the apparatus to perform a method in accordance with any one of examples 1-30.

Example 33 is an access point (AP) comprising: a transceiver; a memory comprising instructions; and one or more processors configured to execute the instructions to cause the AP to perform a method in accordance with any one of examples 1-30, wherein the transceiver is configured to: transmit the request for channel resources; and receive the response to the request.

### ADDITIONAL CONSIDERATIONS

As used herein, the terms “negotiating,” “scheduling,” “reducing,” “advertising,” “modifying,” “generating,” and/or “determining” (or any variants thereof such as “advertise,” “modify,” “generate,” and determine”) encompass a wide variety of actions. For example, “scheduling,” “negotiating,” “reducing,” “modifying,” “generating,” and/or “determining” may include calculating, computing, processing, deriving, investigating, looking up (e.g., looking up in a table, a database or another data structure), ascertaining and the like. Also, “negotiating” and “advertising” may include accessing (e.g., accessing data in a memory), transmitting (e.g., broadcasting) data and the like. Also, “modifying,” “generating,” and/or “determining” may include resolving, selecting, choosing, establishing and the like.

The preceding description provides examples of techniques for increasing local area network (LAN) device privacy in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus configured for wireless communication, comprising:
a memory comprising instructions; and
one or more processors configured to execute the instructions and cause the apparatus to:
output, for transmission to a network node, a request for channel resources comprising an indication of one or more channel resources within a spectrum; and
obtain, from the network node, a response to the request, the response providing the apparatus with access to the indicated one or more channel resources within the spectrum.

2. The apparatus of claim 1, wherein the indicated one or more channel resources comprise a primary subchannel, and wherein the one or more processors are further configured to cause the apparatus to:
output, for transmission to at least one of a wireless node or a client, at least one first frame via the primary subchannel; and
obtain, from at least one of the wireless node or the client, at least one second frame via the primary subchannel.

3. The apparatus of claim 2, wherein the one or more processors of the apparatus are further configured to cause the apparatus to:
communicate coordinated signaling with the wireless node, wherein the coordinated signaling comprises transmission scheduling information.

4. The apparatus of claim 1, wherein the one or more channel resources are associated with 40 MHz or higher bandwidth, and wherein the spectrum is a 70 MHz band.

5. The apparatus of claim 1, wherein the spectrum is a 70 MHz priority access license (PAL) spectrum, wherein a citizen broadband radio spectrum (CBRS) contains the PAL spectrum and a general authorized access (GAA) spectrum, wherein the request for channel resources further comprises an indication of channel resources within the GAA spectrum, and wherein the response to the request further provides the apparatus access to one or more of the indicated channel resources within the GAA spectrum.

6. The apparatus of claim 5, wherein the one or more processors are further configured to cause the apparatus to, at least one of:
obtain or output for transmission at least one frame via a control channel of the CBRS, wherein a bandwidth of the control channel is less than 20 MHz and is located adjacent to an end of the CBRS.

7. The apparatus of claim 6, wherein a physical layer protocol data unit (PPDU) of the at least one frame is formatted by using an 802.11a half-rate PPDU or an 802.11p PPDU.

8. The apparatus of claim 5, wherein the indicated one or more channel resources within the PAL spectrum and the indicated channel resources within the GAA spectrum form an operating bandwidth of a basic service set (BSS) of the apparatus.

9. The apparatus of claim 5, wherein the one or more processors are further configured to cause the apparatus to:
obtain, from the network node, signaling comprising an indication that access to the CBRS has been suspended or terminated.

10. The apparatus of claim 9, wherein the one or more processors are further configured to cause the apparatus to:
output, for transmission to the network node, another request for channel resources comprising an indication of the channel resources available to the apparatus; and
obtain, from the network node, access to the indicated channel resources available to the apparatus.

11. The apparatus of claim 10, wherein the one or more processors are further configured to cause the apparatus to:
modify a puncturing pattern of the CBRS to reflect the channel resources available to the apparatus.

12. The apparatus of claim 11, wherein a granularity of the puncturing pattern is given in chunks of 5 MHz, 10 MHZ, or 15 MHz.

13. The apparatus of claim 5, wherein the one or more processors are further configured to cause the apparatus to:
obtain, from the network node, signaling comprising an indication that access to a channel resource of at least one of the channel resources within the GAA spectrum or the channel resources within the PAL spectrum has been suspended or terminated.

14. The apparatus of claim 13, wherein the one or more processors are further configured to cause the apparatus to:
obtain an indication that access to another channel resource of at least one of the channel resources within the GAA spectrum or the channel resources within the PAL spectrum is available to the apparatus.

15. The apparatus of claim 14, wherein at least one of a reduced neighbor report (RNR) or a multi-link probe response comprises the indication.

16. The apparatus of claim 1, wherein the one or more processors are further configured to cause the apparatus to:
generate, based on the response, a puncturing pattern for the one or more channel resources within the spectrum.

17. The apparatus of claim 16, wherein the response further provides the apparatus access to one or more channel resources within a general authorized access (GAA) spectrum, and wherein the puncturing pattern is generated also for the one or more channel resources within the GAA spectrum.

18. The apparatus of claim 1, wherein the one or more channel resources are associated with 20 MHz or higher of bandwidth.

19. The apparatus of claim 1, wherein the one or more processors are further configured to cause the apparatus to:
output, for transmission to a client, an indication of a maximum transmit power for transmission of signaling via the one or more channel resources.

20. The apparatus of claim 1, wherein the one or more processors are further configured to cause the apparatus to:
obtain instructions for reducing a maximum transmit power for transmission of signaling via the one or more channel resources; and
reduce the maximum transmit power based on the instructions.

21. The apparatus of claim 1, wherein the one or more processors are further configured to cause the apparatus to:
schedule a dedicated service period (D-SP) and an opportunistic service period (O-SP) for communication with one or more clients, wherein the D-SP is reserved for communication with one of the one or more clients, and wherein the O-SP is dynamically scheduled for communication with one of the one or more clients; and
communicate with the one or more clients via the D-SP and O-SP.

22. The apparatus of claim 21, wherein the one or more channel resources are within a 3.5 GHz band, and wherein the one or more processors are further configured to cause the apparatus to:
negotiate the schedule of the D-SP with the one or more clients independent of the 3.5 GHz band.

23. The apparatus of claim 21, wherein the one or more channel resources are within a 3.5 GHz band, and wherein the one or more processors are further configured to cause the apparatus to:
advertise the O-SP independent of the 3.5 GHz band.

24. The apparatus of claim 21, wherein one or more of the D-SP and the O-SP are indicated via a target wake up time (TWT).

25. The apparatus of claim 21, wherein one or more of the D-SP and the O-SP are indicated via a bitmap.

26. The apparatus of claim 25, wherein each bit in the bitmap is configured to identify a time block corresponding to the D-SP or the O-SP, and wherein the bitmap is further configured to at least one of:
advertise one or more time blocks;
request one or more time blocks; or
grant one or more time blocks.

27. The apparatus of claim 1, wherein the one or more processors are further configured to cause the apparatus to:
output, for transmission to one or more clients, a polling message configured to at least one of: (i) indicate to the one or more clients that the one or more channel resources are still available for communication, (ii) request whether any of the one or more clients have buffered data, or (iii) notify the one or more clients that will be served by the apparatus.

28. The apparatus of claim 27, wherein at least one of:
the polling message is output for transmission at a start of a service period; or
the polling message is a trigger frame.

29. The apparatus of claim 1, wherein the one or more channel resources are within a 3.5 GHz band, and wherein the one or more processors are further configured to cause the apparatus to:
output, for transmission independent of the 3.5 GHz band, an advertisement for a service period of the 3.5 GHz band.

30. The apparatus of claim 1, wherein the one or more channel resources are within a 3.5 GHz band, wherein management frames are configured for at least one of discovery, authentication, or association with the 3.5 GHz band, and wherein the one or more processors are further configured to cause the apparatus to:
output, for transmission independent of the 3.5 GHz band, the management frames.

31. An access point (AP) configured for wireless communication, comprising:
a transceiver;
a memory comprising instructions; and
one or more processors configured to execute the instructions and cause the AP to:
transmit, via the transceiver, a request for channel resources comprising an indication of one or more channel resources within a spectrum; and
receive, via the transceiver, a response to the request, the response providing the apparatus with access to the indicated one or more channel resources within the spectrum.
